(19) United States
(12) Patent Application Publication
(10) Pub. No.: US 2025/0111481 A1
(43) Pub. Date: Apr. 3, 2025

(54) TRAINING DATA, TRAINED MODEL, IMAGING APPARATUS, LEARNING DEVICE, METHOD OF CREATING TRAINING DATA, AND METHOD OF GENERATING TRAINED MODEL

(71) Applicant: FUJIFILM Corporation, Tokyo (JP)

(72) Inventor: Satoru OBINATA, Saitama (JP)

(73) Assignee: FUJIFILM Corporation, Tokyo (JP)

(21) Appl. No.: 18/890,083

(22) Filed: Sep. 19, 2024

(30) Foreign Application Priority Data
Sep. 28, 2023 (JP) 2023-168758

(51) Int. Cl. G06T 5/60; G06T 3/4046; G06T 3/4053; G06T 5/30; G06T 5/50

(52) U.S. Cl. CPC G06T 5/60; G06T 3/4046; G06T 3/4053; G06T 5/30; G06T 5/50; G06T 2207/10024; G06T 2207/20081; G06T 2207/20084; G06T 2207/20212

(57) ABSTRACT

Training data is used for machine learning of a model. The training data includes a correct answer image obtained by combining a plurality of single images, and an example image representing the plurality of single images.

### CROSS-REFERENCE TO RELATED APPLICATIONS

This application claims priority under 35 USC 119 from Japanese Patent Application No. 2023-168758 filed on Sep. 28, 2023, the disclosure of which is incorporated by reference herein.

### BACKGROUND

### 1. Technical Field

The present disclosure relates to training data, a trained model, an imaging apparatus, a learning device, a method of creating training data, and a method of generating a trained model.

### 2. Related Art

JP2022-096484A discloses an image processing device comprising an image reception unit that receives a first image and a second image of a different type from the first image with respect to the same target, a first image quality enhancement processing unit that enhances image quality of the first image received by the reception unit using an image quality enhancement function trained to enhance the image quality of the first image, and a second image quality enhancement processing unit that enhances image quality of the second image using a first high image quality image generated by the first image quality enhancement processing unit and the second image. The image processing device according to JP2022-096484A further comprises a learning unit that performs learning of the image quality enhancement function.

JP2022-536807A discloses a computer implementation method for increasing an image resolution of a digital image. The computer implementation method according to JP2022-536807A includes a step of executing bicubic upsampling of a digital image to generate a base high resolution (HR) image, a step of converting the digital image from a red-green-blue (RGB) color space into a brightness (Y), chroma saturation blue difference (Cb), and chroma saturation red difference (Cr) (YCbCr) color space to generate a low resolution (LR) residual image, a step of converting the LR residual image into a plurality of HR residual subimages corresponding to the digital image using a plurality of convolutional layers of a neural network model, and a step of generating an HR image corresponding to the digital image using the base HR image and the plurality of HR residual subimages.

The computer implementation method according to JP2022-536807A further includes a step of training the neural network model using a plurality of training image pairs, in which each training image pair of the plurality of training image pairs includes an LR image corresponding to a training image, and the LR image includes an LR image that has degraded image quality and that is configured as input of the neural network model, and a plurality of HR residual subimages that correspond to the training image and that are configured as target output of the neural network model.

JP2018-151747A discloses a super-resolution processing device that creates an image of a third resolution higher than a second resolution by performing super-resolution processing on an image of the second resolution. The super-resolution processing device according to JP2018-151747A comprises a first layer filter acquisition unit, a reduced image creation unit, a candidate image creation unit, and a super-resolution processing unit. The first layer filter acquisition unit acquires, for each of a plurality of learning subsets of a first layer that are subsets of a learning set including the image of the third resolution, a first filter for performing the super-resolution processing on the image of the second resolution to obtain the image of the third resolution and a second filter for performing the super-resolution processing on an image of a first resolution lower than the second resolution to obtain the image of the second resolution. The first filter and the second filter are obtained through machine learning using the learning subsets. The reduced image creation unit creates a reduced image of the first resolution from an input image of the second resolution. The candidate image creation unit creates a candidate image of the second resolution by performing the super-resolution processing on the reduced image of the first resolution using each second filter acquired by the first layer filter acquisition unit. The super-resolution processing unit creates a super-resolution image of the third resolution by performing the super-resolution processing on the input image of the second resolution using the first filter corresponding to the second filter that minimizes a difference between the candidate image of the second resolution created by the candidate image creation unit and the input image of the second resolution.

### SUMMARY

An embodiment according to the present disclosure provides training data, a trained model, an imaging apparatus, a learning device, a method of creating training data, and a method of generating a trained model that can cause a trained model to generate an image having higher image quality than an input image.

According to a first aspect of the present disclosure, there is provided training data used for machine learning of a model, the training data comprising a correct answer image obtained by combining a plurality of single images, and an example image representing the plurality of single images.

According to a second aspect of the present disclosure, in the training data according to the first aspect, the correct answer image is an image having an enhanced resolution by combining the plurality of single images.

According to a third aspect of the present disclosure, in the training data according to the first or second aspect, the correct answer image is an image having an enhanced resolution compared to the example image.

According to a fourth aspect of the present disclosure, in the training data according to the first or second aspect, the correct answer image is an image having a larger number of pixels than the example image.

According to a fifth aspect of the present disclosure, in the training data according to the first or second aspect, the correct answer image is an image having a higher visual resolution than the example image.

According to a sixth aspect of the present disclosure, in the training data according to the second aspect, each of the plurality of single images is an image subjected to pixel shifting.

According to a seventh aspect of the present disclosure, in the training data according to the sixth aspect, each of the plurality of single images is an image shifted by ½ pixels.

According to an eighth aspect of the present disclosure, in the training data according to the first aspect, each of the plurality of single images is an image subjected to pixel shifting, and the correct answer image is an image having enhanced image quality by combining the plurality of single images.

According to a ninth aspect of the present disclosure, in the training data according to the eighth aspect, pixels of different colors are regularly disposed in the plurality of single images, and each of the plurality of single images is an image subjected to pixel shifting to a position at which the pixels of the different colors overlap.

According to a tenth aspect of the present disclosure, in the training data according to the fifth aspect, the plurality of single images are obtained by performing imaging via a first image sensor including a phase difference pixel and a non-phase difference pixel, and each of the plurality of single images is an image subjected to pixel shifting to a position at which a pixel corresponding to the non-phase difference pixel overlaps with a pixel corresponding to the phase difference pixel.

According to an eleventh aspect of the present disclosure, in the training data according to any one of the first to tenth aspects, the correct answer image is an image having improved image quality compared to the single images because of a factor that affects the image quality, and the example image is an image having degraded image quality compared to the correct answer image because of the factor.

According to a twelfth aspect of the present disclosure, in the training data according to the first aspect, the factor is a focal length, an F number, a lens characteristic, a thinning-out characteristic between pixels, a gradation correction function, a gain correction function, and/or a noise reducing function.

According to a thirteenth aspect of the present disclosure, in the training data according to any one of the first to twelfth aspects, the correct answer image and the example image include a focusing region and a non-focusing region, and the correct answer image is an image in which degrees of image quality enhancement of the focusing region and the non-focusing region are different from each other.

According to a fourteenth aspect of the present disclosure, in the training data according to the thirteenth aspect, the correct answer image is an image in which the degree of image quality enhancement of the non-focusing region is smaller than the degree of image quality enhancement of the focusing region.

According to a fifteenth aspect of the present disclosure, in the training data according to any one of the first to fourteenth aspects, the correct answer image and the example image are RAW images.

According to a sixteenth aspect of the present disclosure, in the training data according to any one of the first to fourteenth aspects, the correct answer image and the example image are images based on a RAW image.

According to a seventeenth aspect of the present disclosure, in the training data according to any one of the first to sixteenth aspects, the correct answer image and the example image are images of an RGB format or images of a YCbCr format.

According to an eighteenth aspect of the present disclosure, in the training data according to any one of the first to seventeenth aspects, the example image is a first image based on the single images of a number smaller than the number of the plurality of single images among the plurality of single images.

According to a nineteenth aspect of the present disclosure, in the training data according to any one of the first to eighteenth aspects, the example image is a second image obtained by thinning out a pixel in the single images of a number less than or equal to the number of the plurality of single images among the plurality of single images.

According to a twentieth aspect of the present disclosure, in the training data according to any one of the first to nineteenth aspects, each of the plurality of single images is an image that is obtained by performing imaging from different imaging positions via a second image sensor and that is shifted by ½ pixels, and the example image is a single image having a center closest to a centroid in a case where the plurality of single images are superimposed on each other among the plurality of single images.

According to a twenty-first aspect of the present disclosure, in the training data according to any one of the first to twentieth aspects, the example image is a single image having a false color and/or a false resolution among the plurality of single images or an image generated based on the single image having the false color and/or the false resolution among the plurality of single images.

According to a twenty-second aspect of the present disclosure, there is provided a trained model that is generated by optimizing the model by performing the machine learning on the model using the training data according to any one of the first to twenty-first aspects.

According to a twenty-third aspect of the present disclosure, there is provided an imaging apparatus comprising a first processor, and a third image sensor, in which the first processor is configured to input a captured image obtained by performing imaging via the third image sensor into the trained model according to the twenty-second aspect, and acquire an inference result output from the trained model in accordance with input of the captured image.

According to a twenty-fourth aspect of the present disclosure, there is provided a learning device comprising a second processor, in which the second processor is configured to optimize the model by performing the machine learning on the model using the training data according to any one of the first to twenty-first aspects.

According to a twenty-fifth aspect of the present disclosure, there is provided a method of creating training data used for machine learning of a model, the training data including a correct answer image and an example image, the method comprising creating the correct answer image by combining a plurality of single images, and creating an image representing the plurality of single images as the example image.

According to a twenty-sixth aspect of the present disclosure, there is provided a method of generating a trained model that is generated by performing machine learning on a model using training data including a correct answer image and an example image, the correct answer image being an image obtained by combining a plurality of single images, the example image being an image representing the plurality of single images, the method comprising inputting the example image into the model, outputting an evaluation target image in accordance with input of the example image via the model, and optimizing the model based on a comparison result between the evaluation target image and the correct answer image.

### BRIEF DESCRIPTION OF THE DRAWINGS

Exemplary embodiments of the technology of the disclosure will be described in detail based on the following figures, wherein:

FIG. 1 is a schematic configuration diagram illustrating an example of an overall configuration of an imaging apparatus;

FIG. 2 is a schematic configuration diagram illustrating an example of hardware configurations of an optical system and an electrical system of the imaging apparatus;

FIG. 3 is a schematic configuration diagram illustrating an example of a configuration of a learning device;

FIG. 4 is a conceptual diagram illustrating an example of a method of creating a correct answer image;

FIG. 5 is a conceptual diagram illustrating an example of a method of creating an example image;

FIG. 6 is a block diagram illustrating an example of a function of an image processing engine;

FIG. 7 is a flowchart illustrating an example of a flow of learning processing performed by the learning device;

FIG. 8 is a flowchart illustrating an example of a flow of image quality enhancement processing performed by the imaging apparatus;

FIG. 9 is a conceptual diagram illustrating a first modification example of a method of creating training data;

FIG. 10 is a conceptual diagram illustrating a second modification example of the method of creating the training data;

FIG. 11 is a conceptual diagram illustrating a third modification example of the method of creating the training data;

FIG. 12 is a conceptual diagram illustrating a fourth modification example of the method of creating the training data;

FIG. 13 is a conceptual diagram illustrating an example of a configuration of training data used for improving image quality of a focusing region compared to that of a non-focusing region;

FIG. 14 is a conceptual diagram illustrating an example of a configuration of training data including an example image that has degraded image quality because of a factor and that has a false color and a false resolution, and a correct answer image that has enhanced image quality compared to the example image; and

FIG. 15 is a conceptual diagram illustrating an example of an aspect in which both of the correct answer image and the example image are JPEG files including images of an RGB format.

### DETAILED DESCRIPTION

Hereinafter, an example of embodiments of training data, a trained model, an imaging apparatus, a learning device, a method of creating training data, and a method of generating a trained model according to the present disclosure will be described with reference to the accompanying drawings.

First, terms used in the following description will be described.

CPU refers to the abbreviation for “Central Processing Unit”. GPU refers to the abbreviation for “Graphics Processing Unit”. GPGPU refers to the abbreviation for “General-Purpose computing on Graphics Processing Units”. APU refers to the abbreviation for “Accelerated Processing Unit”. TPU refers to the abbreviation for “Tensor Processing Unit”. NVM refers to the abbreviation for “Non-Volatile Memory”. RAM refers to the abbreviation for “Random Access Memory”. IC refers to the abbreviation for “Integrated Circuit”. ASIC refers to the abbreviation for “Application Specific Integrated Circuit”. PLD refers to the abbreviation for “Programmable Logic Device”. FPGA refers to the abbreviation for “Field-Programmable Gate Array”. SoC refers to the abbreviation for “System-on-a-Chip”. SSD refers to the abbreviation for “Solid State Drive”. USB refers to the abbreviation for “Universal Serial Bus”. HDD refers to the abbreviation for “Hard Disk Drive”. EEPROM refers to the abbreviation for “Electrically Erasable and Programmable Read Only Memory”. EL refers to the abbreviation for “Electro-Luminescence”. I/F refers to the abbreviation for “Interface”. UI refers to the abbreviation for “User Interface”. fps refers to the abbreviation for “frame per second”. MF refers to the abbreviation for “Manual Focus”. AF refers to the abbreviation for “Auto Focus”. CMOS refers to the abbreviation for “Complementary Metal Oxide Semiconductor”. CCD refers to the abbreviation for “Charge Coupled Device”. AI refers to the abbreviation for “Artificial Intelligence”. A/D refers to the abbreviation for “Analog/Digital”. FIR refers to the abbreviation for “Finite Impulse Response”. IIR refers to the abbreviation for “Infinite Impulse Response”. JPEG refers to the abbreviation for “Joint Photographic Experts Group”. TIFF refers to the abbreviation for “Tagged Image File Format”. JPEG XR refers to the abbreviation for “Joint Photographic Experts Group Extended Range”. MPEG refers to the abbreviation for “Moving Picture Expert Group”. AVI refers to the abbreviation for “Audio Video Interleaved”. MTF refers to the abbreviation for “Modulation Transfer Function”.

In the following description, a processor with a reference numeral (hereinafter, simply referred to as the “processor”) may be one physical or virtual operation device or a combination of a plurality of physical or virtual operation devices. The processor may be one type of operation device or a combination of a plurality of types of operation devices. Examples of the operation device include a CPU, a GPU, a GPGPU, an APU, or a TPU.

In the following description, a memory with a reference numeral is a memory such as a RAM temporarily storing information and is used as a work memory by the processor.

In the following description, a storage with a reference numeral is one or a plurality of non-volatile storage devices storing various programs and various parameters or the like. Examples of the non-volatile storage device include a flash memory, a magnetic disk, or a magnetic tape. Other examples of the storage include a cloud storage.

In the following embodiment, an external I/F with a reference numeral controls exchange of various types of information among a plurality of apparatuses connected to each other. Examples of the external I/F include a USB interface. A communication I/F including a communication processor and an antenna or the like may be applied to the external I/F. The communication I/F controls communication among a plurality of computers. Examples of a communication standard applied to the communication I/F include a wireless communication standard including 5G, Wi-Fi (registered trademark), or Bluetooth (registered trademark).

In the following embodiment, “A and/or B” is synonymous with “at least one of A or B”. That is, “A and/or B” may mean only A, only B, or a combination of A and B. In the present specification, the same approach as “A and/or B” also applies to an expression of three or more matters connected with “and/or”.

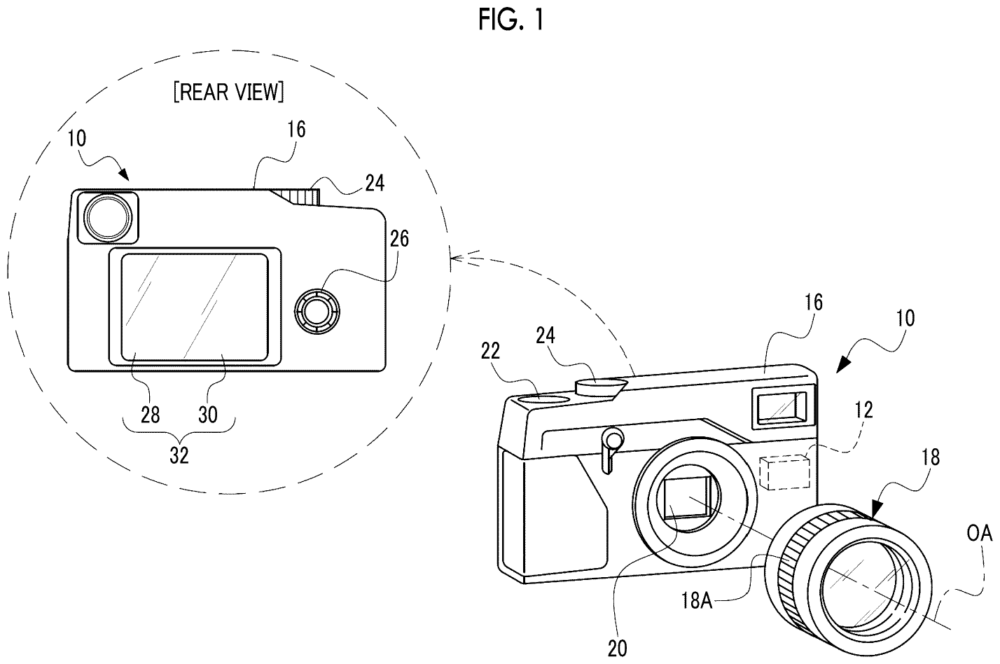

FIG. 1 is a schematic configuration diagram illustrating an example of an overall configuration of an imaging apparatus. As illustrated in FIG. 1, the imaging apparatus 10 is an apparatus that images a subject, and comprises an image processing engine 12, an imaging apparatus body 16, and an interchangeable lens 18. The imaging apparatus 10 is an example of an “imaging apparatus” according to the present disclosure.

The image processing engine 12 is incorporated in the imaging apparatus body 16 and controls the entire imaging apparatus 10. The interchangeable lens 18 is interchangeably mounted on the imaging apparatus body 16. The interchangeable lens 18 is provided with a focus ring 18A. The focus ring 18A is operated by a user or the like in a case where the user or the like (hereinafter, simply referred to as the “user”) of the imaging apparatus 10 manually adjusts focus of the imaging apparatus 10 on the subject.

In the example illustrated in FIG. 1, a lens-interchangeable digital camera is illustrated as an example of the imaging apparatus 10. However, this is merely an example. The imaging apparatus 10 may be a lens-fixed digital camera or a digital camera incorporated in various electronic apparatuses such as a smart device, a wearable terminal, an endoscope apparatus, a cell observation apparatus, an ophthalmic observation apparatus, or a surgical microscope.

The imaging apparatus body 16 is provided with an image sensor 20. The image sensor 20 is an example of a “third image sensor” according to the present disclosure. The image sensor 20 is a CMOS image sensor. The image sensor 20 images an imaging range including at least one subject. In a case where the interchangeable lens 18 is mounted on the imaging apparatus body 16, an image of subject light indicating the subject is formed on the image sensor 20 through the interchangeable lens 18, and image data indicating an image of the subject is generated by the image sensor 20.

While a CMOS image sensor is illustrated as the image sensor 20 in the present embodiment, the present disclosure is not limited to this. For example, the present disclosure is also established in a case where the image sensor 20 is other types of image sensors such as a CCD image sensor.

A release button 22 and a dial 24 are provided on an upper surface of the imaging apparatus body 16. The dial 24 is operated in setting an operation mode of an imaging system, an operation mode of a playback system, and the like. An imaging mode, a playback mode, and a setting mode are selectively set in the imaging apparatus 10 as an operation mode by operating the dial 24. The imaging mode is an operation mode for performing imaging via the imaging apparatus 10. The playback mode is an operation mode for playing back an image (for example, a static image and/or a video) obtained by performing imaging for recording in the imaging mode. The setting mode is an operation mode for setting the imaging apparatus 10 in, for example, setting various set values used for a control related to imaging.

The release button 22 functions as an imaging preparation instruction unit and an imaging instruction unit, and a push operation of two phases of an imaging preparation instruction state and an imaging instruction state can be detected. For example, the imaging preparation instruction state refers to a state of pushing to an intermediate position (half push position) from a standby position, and the imaging instruction state refers to a state of pushing to a final push position (full push position) beyond the intermediate position.

Hereinafter, the “state of pushing to the half push position from the standby position” will be referred to as a “half push state”, and the “state of pushing to the full push position from the standby position” will be referred to as a “full push state”. Depending on a configuration of the imaging apparatus 10, the imaging preparation instruction state may be a state where a finger of the user is in contact with the release button 22, and the imaging instruction state may be a state after a transition from a state where the finger of the user performing an operation is in contact with the release button 22 to a state where the finger of the user is separated from the release button 22.

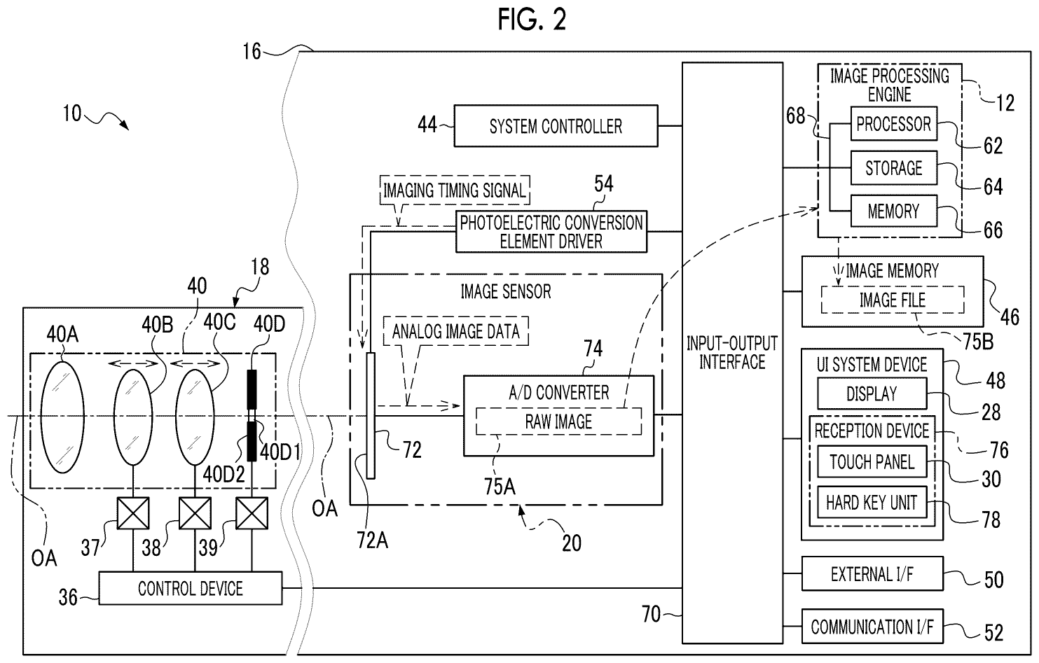

An instruction key 26 and a touch panel display 32 are provided on a rear surface of the imaging apparatus body 16. The touch panel display 32 comprises a display 28 and a touch panel 30 (refer to FIG. 2). Examples of the display 28 include an EL display (for example, an organic EL display or an inorganic EL display). The display 28 may be other types of displays such as a liquid crystal display instead of an EL display.

The display 28 displays an image and/or text information or the like. The display 28 is used for imaging for a live view image, that is, displaying a live view image obtained by performing continuous imaging, in a case where the imaging apparatus 10 is in the imaging mode. The “live view image” refers to a video for display based on the image data obtained by performing imaging via the image sensor 20. For example, the imaging for obtaining the live view image (hereinafter, referred to as “imaging for the live view image”) is performed at a frame rate of 60 fps. 60 fps is merely an example. A frame rate less than 60 fps or a frame rate exceeding 60 fps may be used.

The display 28 is also used for displaying a static image obtained by performing imaging for a static image in a case where an instruction to perform the imaging for the static image is provided to the imaging apparatus 10 through the release button 22. The display 28 is also used for displaying a playback image or the like in a case where the imaging apparatus 10 is in the playback mode. The display 28 is also used for displaying a menu screen on which various menus can be selected, and displaying a setting screen for setting various set values or the like used for the control related to imaging in a case where the imaging apparatus 10 is in the setting mode.

The touch panel 30 is a transmissive touch panel and is overlaid on a surface of a display region of the display 28. The touch panel 30 receives an instruction from the user by detecting a contact of a finger or an indicator such as a stylus pen. Hereinafter, for convenience of description, the above “full push state” will also include a state where the user turns a softkey for starting imaging on through the touch panel 30.

While an out-cell touch panel display in which the touch panel 30 is overlaid on the surface of the display region of the display 28 is illustrated as an example of the touch panel display 32 in the present embodiment, this is merely an example. For example, an on-cell or in-cell touch panel display can also be applied as the touch panel display 32.

The instruction key 26 receives various instructions. For example, the “various instructions” refer to an instruction to display the menu screen, an instruction to select one or a plurality of menus, an instruction to confirm selected content, an instruction to cancel the selected content, and various instructions such as zoom-in, zoom-out, and frame advance. These instructions may also be provided using the touch panel 30.

FIG. 2 is a schematic configuration diagram illustrating an example of hardware configurations of an optical system and an electrical system of the imaging apparatus. As illustrated in FIG. 2, the image sensor 20 comprises a photoelectric conversion element 72. The photoelectric conversion element 72 has a light-receiving surface 72A. The photoelectric conversion element 72 is disposed in the imaging apparatus body 16 such that a center of the light-receiving surface 72A matches an optical axis OA (refer to FIG. 1). The photoelectric conversion element 72 has a plurality of photosensitive pixels disposed in a matrix, and the light-receiving surface 72A is formed by the plurality of photosensitive pixels. Each photosensitive pixel includes a microlens (not illustrated). Each photosensitive pixel is a physical pixel including a photodiode (not illustrated), photoelectrically converts received light, and outputs an electrical signal corresponding to a quantity of the received light.

In the plurality of photosensitive pixels, color filters (not illustrated) of three primary colors of light, that is, red (hereinafter, referred to as “R”), green (hereinafter, referred to as “G”), or blue (hereinafter, referred to as “B”), are disposed in a predetermined pattern arrangement. In the present embodiment, a Bayer arrangement is used as an example of the predetermined pattern arrangement. However, the Bayer arrangement is merely an example. The present disclosure is also established in a case where the predetermined pattern arrangement is other types of pattern arrangements such as a G stripe R/G full checkered arrangement, an X-Trans (registered trademark) arrangement, or a honeycomb arrangement.

Hereinafter, for convenience of description, a photosensitive pixel including a microlens and a color filter of R will be referred to as an R pixel, a photosensitive pixel including a microlens and a color filter of G will be referred to as a G pixel, and a photosensitive pixel including a microlens and a color filter of B will be referred to as a B pixel. Hereinafter, for convenience of description, an electrical signal output from the R pixel of the photosensitive pixel will be referred to as an “R signal”, an electrical signal output from the G pixel of the photosensitive pixel will be referred to as a “G signal”, and an electrical signal output from the B pixel of the photosensitive pixel will be referred to as a “B signal”. Hereinafter, for convenience of description, the R signal, the G signal, and the B signal will be referred to as “color signals of RGB”. Hereinafter, for convenience of description, a pixel of R, a pixel of G, and a pixel of B constituting a RAW image 75A generated based on the color signals of RGB will also be referred to as the “R pixel”, the “G pixel”, and the “B pixel”. While the R pixel, the G pixel, and the B pixel are illustrated, this is merely an example. In a case where colors other than R, G, and B (that is, colors other than the primary colors) are also regularly disposed in the color filters together with R, G, and B, the RAW image 75A also includes pixels of colors other than the R pixel, the G pixel, and the B pixel, and the present disclosure is also established in this case.

The interchangeable lens 18 comprises an imaging lens 40. The imaging lens 40 includes an objective lens 40A, a focus lens 40B, a zoom lens 40C, and a stop 40D. The objective lens 40A, the focus lens 40B, the zoom lens 40C, and the stop 40D are disposed in an order of the objective lens 40A, the focus lens 40B, the zoom lens 40C, and the stop 40D along the optical axis OA from a subject side (object side) to a side closer to the imaging apparatus body 16 (image side).

The interchangeable lens 18 also comprises a control device 36, a first actuator 37, a second actuator 38, and a third actuator 39. The control device 36 controls the entire interchangeable lens 18 in accordance with an instruction from the imaging apparatus body 16. For example, the control device 36 is a device including a computer including a processor, a storage, and a memory. For example, the storage of the control device 36 is an EEPROM. The storage of the control device 36 stores various programs and various parameters. For example, the memory of the control device 36 is a RAM, temporarily stores various types of information, and is used as a work memory. In the control device 36, the processor controls the entire imaging lens 40 by reading out a necessary program from the storage and executing read various programs on the memory.

While a device including a computer is illustrated as an example of the control device 36, this is merely an example. A device including an ASIC, an FPGA, and/or a PLD may be applied. For example, a device implemented by a combination of a hardware configuration and a software configuration may also be used as the control device 36.

The first actuator 37 comprises a slide mechanism for focus (not illustrated) and a motor for focus (not illustrated). The focus lens 40B is attached to the slide mechanism for focus in a slidable manner along the optical axis OA. The motor for focus is connected to the slide mechanism for focus. The slide mechanism for focus operates by receiving motive power of the motor for focus and moves the focus lens 40B along the optical axis OA.

The second actuator 38 comprises a slide mechanism for zoom (not illustrated) and a motor for zoom (not illustrated). The zoom lens 40C is attached to the slide mechanism for zoom in a slidable manner along the optical axis OA. The motor for zoom is connected to the slide mechanism for zoom. The slide mechanism for zoom operates by receiving motive power of the motor for zoom and moves the zoom lens 40C along the optical axis OA.

The third actuator 39 comprises a motive power transmission mechanism (not illustrated) and a motor for the stop (not illustrated). The stop 40D has an opening 40D1 and is a stop in which a size of the opening 40D1 is variable. For example, the opening 40D1 is formed by a plurality of stop leaf blades 40D2. The plurality of stop leaf blades 40D2 are connected to the motive power transmission mechanism. The motor for the stop is connected to the motive power transmission mechanism. The motive power transmission mechanism transmits motive power of the motor for the stop to the plurality of stop leaf blades 40D2. The plurality of stop leaf blades 40D2 operate by receiving the motive power transmitted from the motive power transmission mechanism and change the size of the opening 40D1. Exposure of the stop 40D is adjusted by changing the size of the opening 40D1.

The motor for focus, the motor for zoom, and the motor for the stop are connected to the control device 36, and driving of each of the motor for focus, the motor for zoom, and the motor for the stop is controlled by the control device 36. In the present embodiment, stepping motors are employed as examples of the motor for focus, the motor for zoom, and the motor for the stop. Accordingly, the motor for focus, the motor for zoom, and the motor for the stop operate by synchronizing with a pulse signal in accordance with an instruction from the control device 36. While an example in which the interchangeable lens 18 is provided with the motor for focus, the motor for zoom, and the motor for the stop is illustrated, this is merely an example. The imaging apparatus body 16 may be provided with at least one of the motor for focus, the motor for zoom, or the motor for the stop. Constituents and/or an operation method of the interchangeable lens 18 can be changed, as necessary.

In the imaging apparatus 10, in the imaging mode, an MF mode and an AF mode are selectively set in accordance with an instruction provided to the imaging apparatus body 16. The MF mode is an operation mode for manual focusing. In the MF mode, for example, the focus is adjusted by causing the user to operate the focus ring 18A or the like to move the focus lens 40B along the optical axis OA by a movement amount corresponding to an operation amount of the focus ring 18A or the like.

In the AF mode, the focus is adjusted by causing the imaging apparatus body 16 to perform an operation for a focusing position corresponding to a subject distance and move the focus lens 40B to the focusing position obtained by the operation. The focusing position refers to a position of the focus lens 40B on the optical axis OA in an in-focus state.

The imaging apparatus body 16 comprises the image sensor 20, the image processing engine 12, a system controller 44, an image memory 46, a UI system device 48, an external I/F 50, a communication I/F 52, a photoelectric conversion element driver 54, and an input-output interface 70. The image sensor 20 comprises the photoelectric conversion element 72 and an A/D converter 74.

The image processing engine 12, the image memory 46, the UI system device 48, the external I/F 50, the photoelectric conversion element driver 54, a mechanical shutter driver (not illustrated), and the A/D converter 74 are connected to the input-output interface 70. The control device 36 of the interchangeable lens 18 is also connected to the input-output interface 70.

The system controller 44 comprises a processor (not illustrated), a storage (not illustrated), and a memory (not illustrated). In the system controller 44, the storage is a computer-readable non-transitory storage medium and stores various parameters and various programs. For example, the storage of the system controller 44 is an EEPROM. However, this is merely an example. An HDD and/or an SSD or the like may be applied as the storage of the system controller 44 instead of an EEPROM or together with an EEPROM. The memory of the system controller 44 temporarily stores various types of information and is used as a work memory. In the system controller 44, the processor controls the entire imaging apparatus 10 by reading out a necessary program from the storage and executing read various programs on the memory. That is, in the example illustrated in FIG. 2, the image processing engine 12, the image memory 46, the UI system device 48, the external I/F 50, the communication I/F 52, the photoelectric conversion element driver 54, and the control device 36 are controlled by the system controller 44.

The image processing engine 12 operates under control of the system controller 44. The image processing engine 12 comprises a processor 62, a storage 64, and a memory 66. The processor 62 is an example of a “first processor” according to the present disclosure.

The processor 62, the storage 64, and the memory 66 are connected to each other through a bus 68, and the bus 68 is connected to the input-output interface 70. While one bus is illustrated in the example illustrated in FIG. 2 as the bus 68 for convenience of illustration, a plurality of buses may be used. The bus 68 may be a serial bus or a parallel bus including a data bus, an address bus, a control bus, and the like.

The storage 64 is a computer-readable non-transitory storage medium and stores various parameters and various programs different from the various parameters and the various programs stored in the storage of the system controller 44. For example, the storage 64 is an EEPROM. However, this is merely an example. An HDD and/or an SSD or the like may be applied as the storage 64 instead of an EEPROM or together with an EEPROM. For example, the memory 66 is a RAM, temporarily stores various types of information, and is used as a work memory.

The processor 62 reads out a necessary program from the storage 64 and executes the read program in the memory 66. The processor 62 performs image processing in accordance with the program executed on the memory 66.

The photoelectric conversion element driver 54 is connected to the photoelectric conversion element 72. The photoelectric conversion element driver 54 supplies an imaging timing signal defining a timing of imaging performed by the photoelectric conversion element 72 to the photoelectric conversion element 72 in accordance with an instruction from the processor 62. The photoelectric conversion element 72 performs a reset, exposure, and output of an electrical signal in accordance with the imaging timing signal supplied from the photoelectric conversion element driver 54. Examples of the imaging timing signal include a vertical synchronization signal and a horizontal synchronization signal.

In a case where the interchangeable lens 18 is mounted on the imaging apparatus body 16, the image of the subject light incident on the imaging lens 40 is formed on the light-receiving surface 72A by the imaging lens 40. Under control of the photoelectric conversion element driver 54, the photoelectric conversion element 72 photoelectrically converts the subject light received by the light-receiving surface 72A and outputs an electrical signal corresponding to a light quantity of the subject light to the A/D converter 74 as analog image data indicating the subject light. Specifically, the A/D converter 74 reads out the analog image data from the photoelectric conversion element 72 in frame units for each horizontal line using an exposure and sequential readout method.

The A/D converter 74 generates the RAW image 75A by converting the analog image data into a digital form. The RAW image 75A is an image in which R pixels, G pixels, and B pixels are arranged in a mosaic. The RAW image 75A is an example of a “captured image” according to the present disclosure. In the present embodiment, for example, the number of bits (in other words, a bit length, the number of color bits, or a color depth) that is a value representing a gradation of each pixel including the R pixels, the B pixels, and the G pixels included in the RAW image 75A are 14 bits. 14 bits are merely an example. The number of bits may exceed 14 bits or be less than 14 bits.

In the present embodiment, for example, the processor 62 of the image processing engine 12 acquires the RAW image 75A from the A/D converter 74 and generates an image file 75B by performing the image processing including development on the acquired RAW image 75A. The development refers to processing of compressing a brightness color difference signal in accordance with a predetermined compression method. Examples of the predetermined compression method (that is, a format of the image file) include JPEG, TIFF, JPEG XR, MPEG, or AVI. The image processing includes image quality adjustment of the RAW image 75A. The image quality adjustment of the RAW image 75A is implemented by focal length adjustment, F number adjustment, lens characteristic adjustment, thinning-out characteristic adjustment between pixels P, a gradation correction function (for example, processing of correcting a gradation of an RGB image in accordance with a gamma value), a gain correction function, a noise reducing function, and the like. Other examples of the image quality adjustment of the RAW image 75A include color space conversion processing (that is, processing of converting a color space of an RGB image on which gamma correction processing is performed from an RGB color space to a YCbCr color space), brightness filter processing (that is, processing of filtering a brightness signal (so-called Y signal) using a brightness filter (not illustrated)), color difference processing (that is, processing of performing filtering of reducing high-frequency noise in a Cb signal and a Cr signal), and/or resize processing (that is, processing of adjusting the brightness color difference signal such that a size of an image indicated by the brightness color difference signal matches a size provided by an instruction of the user or the like).

Examples of the image file 75B include a JPEG file. The JPEG file is merely an example. The image file 75B may be other types of image files such as a JPEG XR file, a TIFF file, an MPEG file, MPEG, or AVI. The image file 75B is stored in the image memory 46 by the processor 62.

The UI system device 48 comprises the display 28, and the processor 62 displays various types of information on the display 28. The UI system device 48 also comprises a reception device 76. The reception device 76 comprises the touch panel 30 and a hard key unit 78. The hard key unit 78 includes a plurality of hard keys including the instruction key 26 (refer to FIG. 1). The processor 62 operates in accordance with various instructions received by the touch panel 30. While the hard key unit 78 is included in the UI system device 48, the present disclosure is not limited to this. For example, the hard key unit 78 may be connected to the external I/F 50.

The external I/F 50 controls exchange of various types of information with an apparatus present outside the imaging apparatus 10 (hereinafter, referred to as an “external apparatus”). Examples of the external I/F 50 include a USB interface. The external apparatus (not illustrated) such as a smart device, a personal computer, a server, a USB memory, a memory card, and/or a printer is directly or indirectly connected to the USB interface.

The communication I/F 52 is connected to a network (not illustrated). The communication I/F 52 controls exchange of information between a communication device (not illustrated) such as a server on the network and the system controller 44. For example, the communication I/F 52 transmits information corresponding to a request from the system controller 44 to the communication device through the network. The communication I/F 52 receives information transmitted from the communication device and outputs the received information to the system controller 44 through the input-output interface 70.

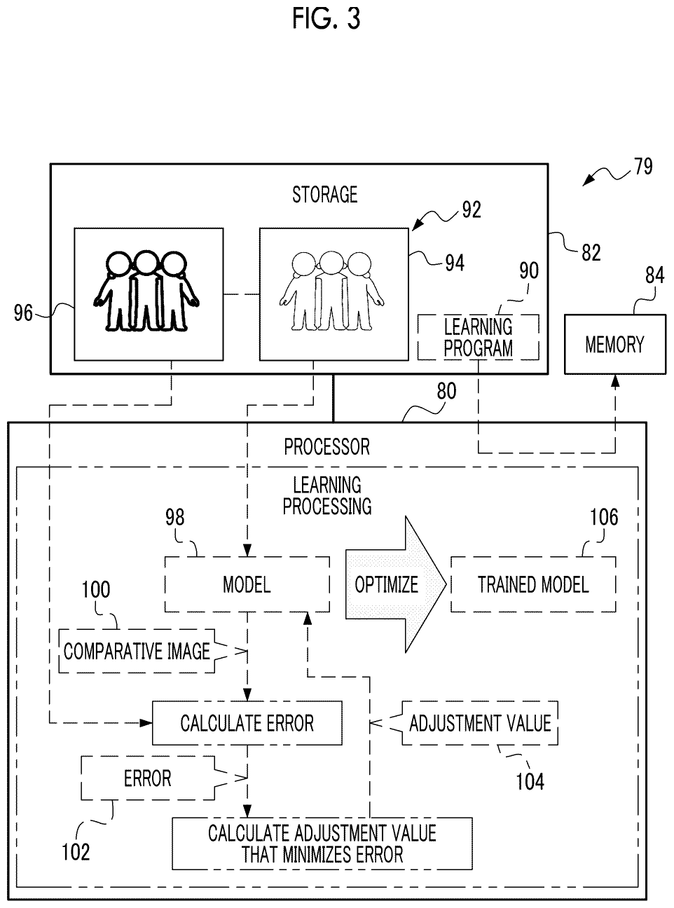

The image processing engine 12 performs processing of enhancing image quality of the RAW image 75A by applying an AI to the RAW image 75A. Therefore, hereinafter, a method of generating the AI applied to the RAW image 75A will be described with reference to FIGS. 3 to 5.

FIG. 3 is a conceptual diagram illustrating an example of a configuration of a learning device 79. As illustrated in FIG. 3, the learning device 79 comprises a processor 80, a storage 82, and a memory 84. Hardware configurations of the processor 80, the storage 82, the memory 84, and the like in the learning device 79 are basically the same as the hardware configurations of the processor 62, the storage 64, the memory 66, and the like described above and thus, will not be described. In the example illustrated in FIG. 3, the learning device 79 is an example of a “learning device” according to the present disclosure.

A learning program 90 is stored in the storage 82. The processor 80 is an example of a “second processor” according to the present disclosure. The processor 80 reads out the learning program 90 from the storage 82 and executes the read learning program 90 on the memory 84. The processor 80 performs learning processing in accordance with the learning program 90 executed on the memory 84. The learning processing is processing of generating a trained model 106 from a model 98. The trained model 106 is generated by executing machine learning on the model 98 via the processor 80. That is, the trained model 106 is generated by optimizing the model 98 through the machine learning. For example, the model 98 is a neural network having several hundred million to several trillion interlayers. Examples of the model 98 include a model for a generative AI that generates and outputs an image having enhanced image quality compared to an input image (for example, an image having at least a resolution that is a multiple of that of the input image).

The storage 82 stores a plurality of (for example, several ten thousand to several hundred billion) pieces of training data 92. The training data 92 is used for the machine learning of the model 98. That is, in the learning device 79, the processor 80 acquires the plurality of pieces of training data 92 from the storage 82 and performs the machine learning on the model 98 using the acquired plurality of pieces of training data 92.

The training data 92 is labeled data. For example, the labeled data is data in which an example image 94 (in other words, example data) and a correct answer image 96 (in other words, correct answer data) are associated with each other. The training data 92 is an example of “training data” according to the present disclosure. The example image 94 is an example of an “example image” according to the present disclosure. The correct answer image 96 is an example of a “correct answer image” according to the present disclosure.

The example image 94 is an image assuming the RAW image 75A. For example, an image assuming the RAW image 75A refers to an image having the same image quality as the RAW image 75A including a resolution. In the present embodiment, an image obtained by actually imaging a sample subject (for example, a subject captured in the correct answer image 96 illustrated in FIG. 3) is used as the example image 94. However, this is merely an example. The image assuming the RAW image 75A may be a virtually generated image. Examples of the virtually generated image include an image generated by a generative AI or the like.

The correct answer image 96 is an image obtained by enhancing image quality of the example image 94. Examples of the image having enhanced image quality include an image having an enhanced resolution compared to the example image 94. For example, the image having an enhanced resolution compared to the example image 94 refers to an image having a larger number of pixels than the example image 94. In other words, the image having an enhanced resolution compared to the example image 94 is an image having a higher visual resolution than the example image 94.

The processor 80 acquires the training data 92 one piece at a time from the storage 82. The processor 80 inputs the example image 94 into the model 98 from the training data 92 acquired from the storage 82. In a case where the example image 94 is input, the model 98 generates a comparative image 100 that is an image having a higher resolution than the example image 94 (that is, an image having a larger number of pixels than the example image 94). The comparative image 100 is an image used to be compared with the correct answer image 96 associated with the example image 94 input into the model 98. In the present embodiment, the comparative image 100 is an example of an “evaluation target image” according to the present disclosure.

The processor 80 calculates an error 102 between the correct answer image 96 associated with the example image 94 input into the model 98 and the comparative image 100. The error 102 is an example of a “comparison result” according to the present disclosure. The processor 80 calculates a plurality of adjustment values 104 that minimize the error 102. The processor 80 adjusts a plurality of optimization variables in the model 98 using the plurality of adjustment values 104. For example, the plurality of optimization variables refer to a plurality of connection weights and a plurality of offset values included in the model 98.

The processor 80 repeats the series of processing of inputting the example image 94 into the model 98, calculating the error 102, calculating the plurality of adjustment values 104, and adjusting the plurality of optimization variables in the model 98, using the plurality of pieces of training data 92 stored in the storage 82. That is, the processor 80 optimizes the model 98 by adjusting the plurality of optimization variables in the model 98 using the plurality of adjustment values 104 that are calculated such that the error 102 is minimized for each of a plurality of example images 94 included in the plurality of pieces of training data 92 stored in the storage 82. The processor 80 generates the trained model 106 by optimizing the model 98. In a case where the example image 94 is input into the trained model 106 generated as described above, the trained model 106 generates and outputs an image having the same resolution as the correct answer image 96 as an image corresponding to the input example image 94.

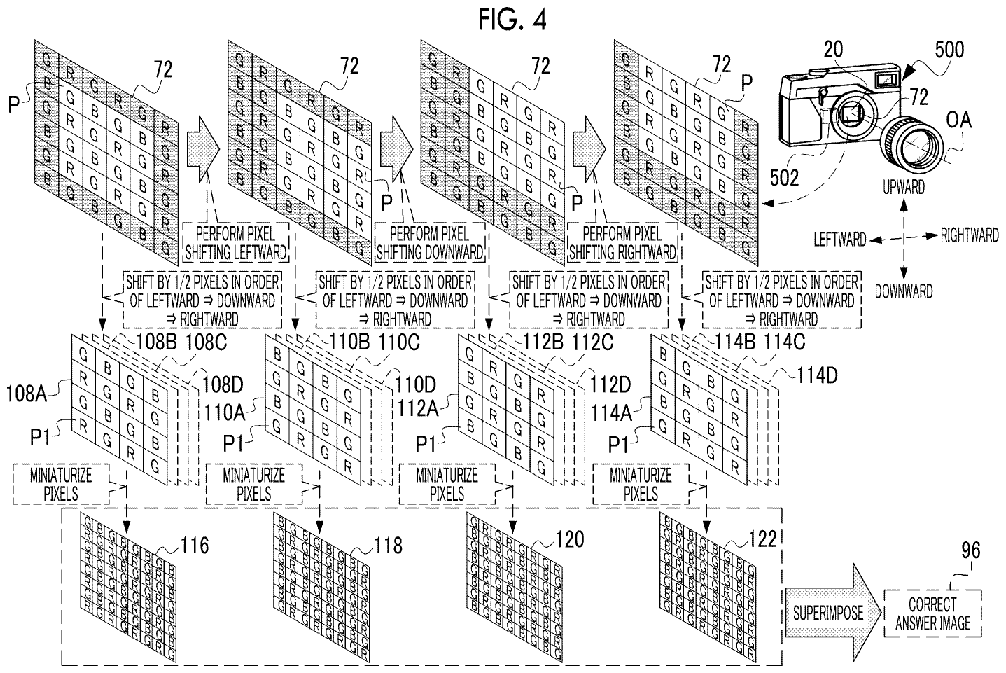

FIG. 4 is a conceptual diagram illustrating an example of a method of creating the correct answer image 96. As illustrated in FIG. 4, in the present embodiment, an imaging apparatus 500 is used for creating the correct answer image 96. The imaging apparatus 500 is different from the imaging apparatus 10 in that the imaging apparatus 500 includes a pixel shifting device 502. As in the imaging apparatus 10, the image sensor 20 mounted on the imaging apparatus 500 is provided with the photoelectric conversion element 72. As in the imaging apparatus 10, the pixels P (that is, R pixels, G pixels, and B pixels) having different colors are regularly disposed in the photoelectric conversion element 72. A disposition pattern of the pixels P having different colors is the same as that of the imaging apparatus 10. In the example illustrated in FIG. 4, a smaller number of pixels P than the actual number of pixels P is illustrated for easy understanding of the present disclosure.

The pixel shifting device 502 is mechanically connected to the photoelectric conversion element 72. The pixel shifting device 502 comprises a motive power source (for example, a voice coil motor) and selectively shifts the photoelectric conversion element 72 upward, downward, leftward, and rightward at a 1 pixel pitch or a ½ (0.5) pixel pitch by transmitting motive power generated by the motive power source to the photoelectric conversion element 72. The pixel shifting device 502 performs pixel shifting on the photoelectric conversion element 72 under control of the system controller 44 (refer to FIG. 2). In the present embodiment, the photoelectric conversion element 72 is selectively shifted by 1 pixel or ½ pixels in upward, downward, leftward, and rightward (that is, the photoelectric conversion element 72 selectively moves at a 1 pixel pitch or a ½ (0.5) pixel pitch upward, downward, leftward, and rightward). In the example illustrated in FIG. 4, the image sensor 20 mounted on the imaging apparatus 500 is an example of a “first image sensor” and a “second image sensor” according to the present disclosure.

In the imaging apparatus 500, first to fourth single images 108A to 108D are generated in first to fourth steps, respectively, as RAW images. Fifth to eighth single images 110A to 110D are generated in fifth to eighth steps, respectively, as RAW images. Ninth to twelfth single images 112A to 112D are generated in ninth to twelfth steps, respectively, as RAW images. Thirteenth to sixteenth single images 114A to 114D are generated in thirteenth to sixteenth steps, respectively, as RAW images. First to fourth miniaturized images 116 to 122 are generated in seventeenth to twentieth steps. The correct answer image 96 is generated in a twenty-first step.

In the following description, for convenience of description, the first to fourth single images 108A to 108D, the fifth to eighth single images 110A to 110D, the ninth to twelfth single images 112A to 112D, and the thirteenth to sixteenth single images 114A to 114D will be referred to as “single images (or unit images)” without their reference numerals unless required to be distinguished from each other.

In the first step, the first single image 108A is generated by imaging the sample subject via the image sensor 20 in a state where the photoelectric conversion element 72 is positioned at a home position. In the second step, the second single image 108B is generated by imaging the sample subject via the image sensor 20 in a state where the photoelectric conversion element 72 is shifted by ½ pixels leftward from an imaging position of the photoelectric conversion element 72 in the first step. In the third step, the third single image 108C is generated by imaging the sample subject via the image sensor 20 in a state where the photoelectric conversion element 72 is shifted by ½ pixels downward from the imaging position of the photoelectric conversion element 72 in the second step. In the fourth step, the fourth single image 108D is generated by imaging the sample subject via the image sensor 20 in a state where the photoelectric conversion element 72 is shifted by ½ pixels rightward from the imaging position of the photoelectric conversion element 72 in the third step.

Each of the first to fourth single images 108A to 108D generated as described above is an image that includes regularly disposed pixels P1 of different colors and that is subjected to pixel shifting to a position at which the pixels PI of different colors overlap (that is, an image subjected to pixel shifting that causes the pixels P1 of different colors to overlap). The pixels P1 refer to pixels (in other words, image pixels) constituting the RAW image obtained by performing imaging via the image sensor 20 of the imaging apparatus 500. Positions of the pixels P1 in the RAW image obtained by performing imaging via the image sensor 20 of the imaging apparatus 500 match positions of the pixels P in the photoelectric conversion element 72 of the image sensor 20 mounted on the imaging apparatus 500.

In the fifth step, the fifth single image 110A is generated by imaging the sample subject via the image sensor 20 in a state where the photoelectric conversion element 72 is shifted by 1 pixel leftward from the imaging position of the photoelectric conversion element 72 in the first step. In the sixth step, the sixth single image 110B is generated by imaging the sample subject via the image sensor 20 in a state where the photoelectric conversion element 72 is shifted by ½ pixels leftward from the imaging position of the photoelectric conversion element 72 in the fifth step. In the seventh step, the seventh single image 110C is generated by imaging the sample subject via the image sensor 20 in a state where the photoelectric conversion element 72 is shifted by ½ pixels downward from the imaging position of the photoelectric conversion element 72 in the sixth step. In the eighth step, the eighth single image 110D is generated by imaging the sample subject via the image sensor 20 in a state where the photoelectric conversion element 72 is shifted by ½ pixels rightward from the imaging position of the photoelectric conversion element 72 in the seventh step.

Each of the fifth to eighth single images 110A to 110D generated as described above is an image that includes regularly disposed pixels P1 of different colors and that is subjected to pixel shifting to a position at which the pixels P1 of different colors overlap (that is, an image subjected to pixel shifting that causes the pixels P1 of different colors to overlap).

In the ninth step, the ninth single image 112A is generated by imaging the sample subject via the image sensor 20 in a state where the photoelectric conversion element 72 is shifted by 1 pixel downward from the imaging position of the photoelectric conversion element 72 in the fifth step. In the tenth step, the tenth single image 112B is generated by imaging the sample subject via the image sensor 20 in a state where the photoelectric conversion element 72 is shifted by ½ pixels leftward from the imaging position of the photoelectric conversion element 72 in the ninth step. In the eleventh step, the eleventh single image 112C is generated by imaging the sample subject via the image sensor 20 in a state where the photoelectric conversion element 72 is shifted by ½ pixels downward from the imaging position of the photoelectric conversion element 72 in the tenth step. In the twelfth step, the twelfth single image 112D is generated by imaging the sample subject via the image sensor 20 in a state where the photoelectric conversion element 72 is shifted by ½ pixels rightward from the imaging position of the photoelectric conversion element 72 in the eleventh step.

Each of the ninth to twelfth single images 112A to 112D generated as described above is an image that includes regularly disposed pixels P1 of different colors and that is subjected to pixel shifting to a position at which the pixels P1 of different colors overlap (that is, an image subjected to pixel shifting that causes the pixels P1 of different colors to overlap).

In the thirteenth step, the thirteenth single image 114A is generated by imaging the sample subject via the image sensor 20 in a state where the photoelectric conversion element 72 is shifted by 1 pixel rightward from the imaging position of the photoelectric conversion element 72 in the ninth step. In the fourteenth step, the fourteenth single image 114B is generated by imaging the sample subject via the image sensor 20 in a state where the photoelectric conversion element 72 is shifted by ½ pixels leftward from the imaging position of the photoelectric conversion element 72 in the thirteenth step. In the fifteenth step, the fifteenth single image 114C is generated by imaging the sample subject via the image sensor 20 in a state where the photoelectric conversion element 72 is shifted by ½ pixels downward from the imaging position of the photoelectric conversion element 72 in the fourteenth step. In the sixteenth step, the sixteenth single image 114D is generated by imaging the sample subject via the image sensor 20 in a state where the photoelectric conversion element 72 is shifted by ½ pixels rightward from the imaging position of the photoelectric conversion element 72 in the fifteenth step.

Each of the thirteenth to sixteenth single images 114A to 114D generated as described above is an image that includes regularly disposed pixels P1 of different colors and that is subjected to pixel shifting to a position at which the pixels P1 of different colors overlap (that is, an image subjected to pixel shifting that causes the pixels P1 of different colors to overlap).

In the seventeenth step, the first miniaturized image 116 is created by combining the first to fourth single images 108A to 108D. For example, the first miniaturized image 116 is an image created by superimposing the first to fourth single images 108A to 108D on each other. Each of the first to fourth single images 108A to 108D is an image shifted by ½ pixels. In other words, each of the first to fourth single images 108A to 108D is an image having a relationship of being shifted by ½ pixels from each other. Thus, the first miniaturized image 116 created by superimposing the first to fourth single images 108A to 108D on each other includes the pixels P1 that are divided into four parts of R, G, G, and B. Accordingly, the pixels Pl are miniaturized compared to those of each of the first to fourth single images 108A to 108D, and the resolution is increased.

In the eighteenth step, the second miniaturized image 118 is created by combining the fifth to eighth single images 110A to 110D. For example, the second miniaturized image 118 is an image created by superimposing the fifth to eighth single images 110A to 110D on each other. Each of the fifth to eighth single images 110A to 110D is an image shifted by ½ pixels. In other words, each of the fifth to eighth single images 110A to 110D is an image having a relationship of being shifted by ½ pixels from each other. Thus, the second miniaturized image 118 created by superimposing the fifth to eighth single images 110A to 110D on each other includes the pixels P1 that are divided into four parts of R, G, G, and B. Accordingly, the pixels P1 are miniaturized compared to those of each of the fifth to eighth single images 110A to 110D.

In the nineteenth step, the third miniaturized image 120 is created by combining the ninth to twelfth single images 112A to 112D. For example, the third miniaturized image 120 is an image created by superimposing the ninth to twelfth single images 112A to 112D on each other. Each of the ninth to twelfth single images 112A to 112D is an image shifted by ½ pixels. In other words, each of the ninth to twelfth single images 112A to 112D is an image having a relationship of being shifted by ½ pixels from each other. Thus, the third miniaturized image 120 created by superimposing the ninth to twelfth single images 112A to 112D on each other includes the pixels P1 that are divided into four parts of R, G, G, and B. Accordingly, the pixels P1 are miniaturized compared to those of each of the ninth to twelfth single images 112A to 112D, and the resolution is increased.

In the twentieth step, the fourth miniaturized image 122 is created by combining the thirteenth to sixteenth single images 114A to 114D. For example, the fourth miniaturized image 122 is an image created by combining the thirteenth to sixteenth single images 114A to 114D (For example, an image created by superimposing the thirteenth to sixteenth single images 114A to 114D on each other). Each of the thirteenth to sixteenth single images 114A to 114D is an image shifted by ½ pixels. In other words, each of the thirteenth to sixteenth single images 114A to 114D is an image having a relationship of being shifted by ½ pixels from each other. Thus, the fourth miniaturized image 122 created by superimposing the thirteenth to sixteenth single images 114A to 114D on each other includes the pixels P1 that are divided into four parts of R, G, G, and B. Accordingly, the pixels PI are miniaturized compared to those of each of the thirteenth to sixteenth single images 114A to 114D, and the resolution is increased.

In the twenty-first step, the correct answer image 96 is created by combining (for example, superimposing in units of the pixels P1 at positions corresponding to each other) the first to fourth miniaturized images 116 to 122 created from the first to fourth single images 108A to 108D, the fifth to eighth single images 110A to 110D, the ninth to twelfth single images 112A to 112D, and the thirteenth to sixteenth single images 114A to 114D. The correct answer image 96 created as described above is an image having enhanced image quality compared to each of the first to fourth single images 108A to 108D, the fifth to eighth single images 110A to 110D, the ninth to twelfth single images 112A to 112D, and the thirteenth to sixteenth single images 114A to 114D. In the example illustrated in FIG. 4, the image having enhanced image quality refers to an image having an enhanced resolution. In other words, the correct answer image 96 created as described above is an image having a larger number of pixels than each of the first to fourth single images 108A to 108D, the fifth to eighth single images 110A to 110D, the ninth to twelfth single images 112A to 112D, and the thirteenth to sixteenth single images 114A to 114D. In other words, the correct answer image 96 created as described above is an image having a higher visual resolution than each of the first to fourth single images 108A to 108D, the fifth to eighth single images 110A to 110D, the ninth to twelfth single images 112A to 112D, and the thirteenth to sixteenth single images 114A to 114D. Since the correct answer image 96 is an image obtained by combining the first to fourth miniaturized images 116 to 122, the correct answer image 96 is also an image having higher color reproducibility than each of the first to fourth miniaturized images 116 to 122.

Each of the first to fourth single images 108A to 108D, the fifth to eighth single images 110A to 110D, the ninth to twelfth single images 112A to 112D, and the thirteenth to sixteenth single images 114A to 114D are images generated as RAW images. Thus, the first to fourth miniaturized images 116 to 122 created from the first to fourth single images 108A to 108D, the fifth to eighth single images 110A to 110D, the ninth to twelfth single images 112A to 112D, and the thirteenth to sixteenth single images 114A to 114D are also RAW images. Accordingly, the correct answer image 96 is also created as a RAW image by superimposing the first to fourth miniaturized images 116 to 122 on each other in units of the pixels P1 corresponding to each other.

While an example of a form in which the correct answer image 96 is created based on the first to fourth single images 108A to 108D, the fifth to eighth single images 110A to 110D, the ninth to twelfth single images 112A to 112D, and the thirteenth to sixteenth single images 114A to 114D obtained by imaging the sample subject via the imaging apparatus 500 is illustrated in the example illustrated in FIG. 4, this is merely an example. For example, at least one of the first to fourth single images 108A to 108D, the fifth to eighth single images 110A to 110D, the ninth to twelfth single images 112A to 112D, or the thirteenth to sixteenth single images 114A to 114D used for creating the correct answer image 96 may be virtual images generated by a generative AI. The generative AI may be an AI specialized in generating an image or a generative AI that generates and outputs at least one of the first to fourth single images 108A to 108D, the fifth to eighth single images 110A to 110D, the ninth to twelfth single images 112A to 112D, or the thirteenth to sixteenth single images 114A to 114D in accordance with input instruction data (a so-called prompt), such as ChatGPT using GPT-4 (searched on the internet <https://openai.com/gpt-4>) or the like.

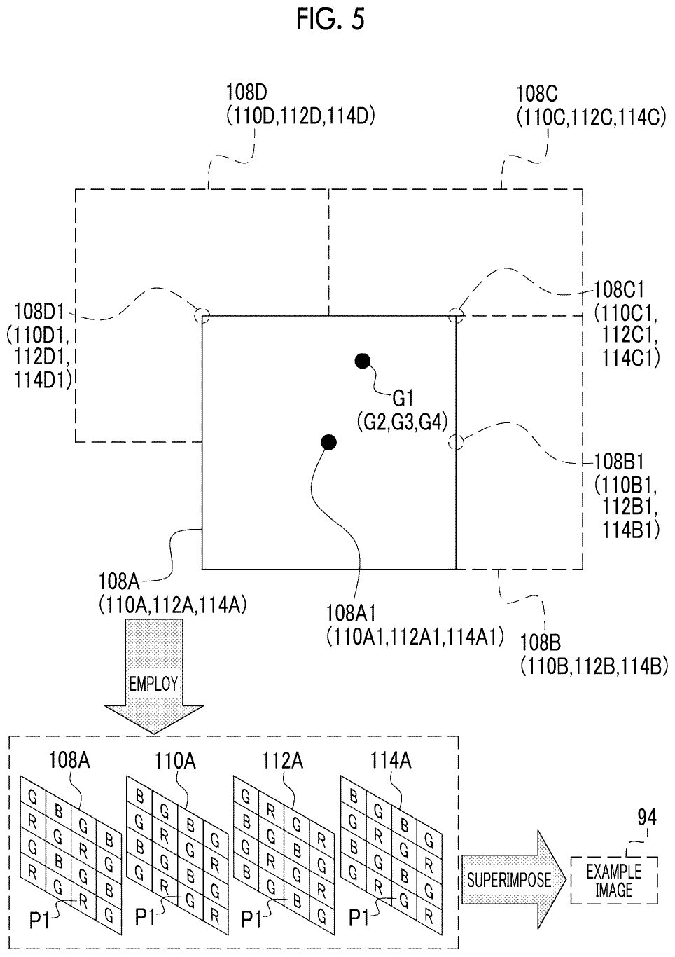

FIG. 5 is a conceptual diagram illustrating an example of a method of creating the example image 94. FIG. 5 illustrates a schematic example of an aspect in a front view of the first to fourth single images 108A to 108D, the fifth to eighth single images 110A to 110D, the ninth to twelfth single images 112A to 112D, and the thirteenth to sixteenth single images 114A to 114D. As illustrated in FIG. 5, the first to fourth single images 108A to 108D have centers 108A1 to 108D1. A centroid G1 in a case where the first to fourth single images 108A to 108D are superimposed on each other is present in the first to fourth single images 108A to 108D. The fifth to eighth single images 110A to 110D also have centers 110A1 to 110D1, respectively. A centroid G2 in a case where the fifth to eighth single images 110A to 110D are superimposed on each other is present in the fifth to eighth single images 110A to 110D. The ninth to twelfth single images 112A to 112D also have centers 112A1 to 112D1, respectively. A centroid G3 in a case where the ninth to twelfth single images 112A to 112D are superimposed on each other is present in the ninth to twelfth single images 112A to 112D. The thirteenth to sixteenth single images 114A to 114D also have centers 114A1 to 114D1, respectively. A centroid G4 in a case where the thirteenth to sixteenth single images 114A to 114D are superimposed on each other is present in the thirteenth to sixteenth single images 114A to 114D.

The example image 94 is an image created by combining (for example, superimposing in units of the pixels P1 at positions corresponding to each other) the first single image 108A, the fifth single image 110A, the ninth single image 112A, and the thirteenth single image 114A. The first single image 108A is an image representing the first to fourth single images 108A to 108D. The fifth single image 110A is an image representing the fifth to eighth single images 110A to 110D. The ninth single image 112A is an image representing the ninth to twelfth single images 112A to 112D. The thirteenth single image 114A is an image representing the thirteenth to sixteenth single images 114A to 114D.

The first single image 108A used for creating the example image 94 is an image having a center closest to the centroid G1 among the first to fourth single images 108A to 108D. That is, the center closest to the centroid G1 among the centers 108A1 to 108D1 is the center 108A1, and the center 108A1 is the center of the first single image 108A. Thus, the first single image 108A is used for creating the example image 94.

The fifth single image 110A used for creating the example image 94 is an image having a center closest to the centroid G2 among the fifth to eighth single images 110A to 110D. That is, the center closest to the centroid G2 among the centers 110A1 to 110D1 is the center 110A1, and the center 110A1 is the center of the fifth single image 110A. Thus, the fifth single image 110A is used for creating the example image 94.

The ninth single image 112A used for creating the example image 94 is an image having a center closest to the centroid G3 among the ninth to twelfth single images 112A to 112D. That is, the center closest to the centroid G3 among the centers 112A1 to 112D1 is the center 112A1, and the center 112A1 is the center of the ninth single image 112A. Thus, the ninth single image 112A is used for creating the example image 94.

The thirteenth single image 114A used for creating the example image 94 is an image having a center closest to the centroid G4 among the thirteenth to sixteenth single images 114A to 114D. That is, the center closest to the centroid G4 among the centers 114A1 to 114D1 is the center 114A1, and the center 114A1 is the center of the thirteenth single image 114A. Thus, the thirteenth single image 114A is used for creating the example image 94.

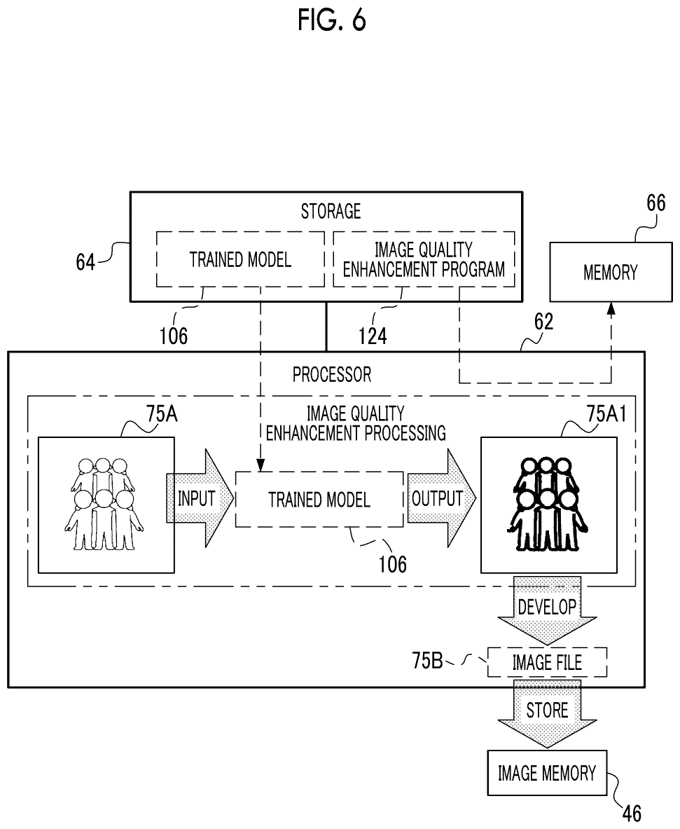

FIG. 6 is a conceptual diagram illustrating an example of an operation phase of the trained model 106 (that is, a phase in which the trained model 106 makes an inference) generated by performing the learning processing in the example illustrated in FIG. 3. As illustrated in FIG. 6, in the imaging apparatus 10, the storage 64 stores the trained model 106. The storage 64 also stores an image quality enhancement program 124. In the imaging apparatus 10, the processor 62 reads out the image quality enhancement program 124 from the storage 64 and executes the read image quality enhancement program 124 on the memory 66. The processor 62 performs image quality enhancement processing in accordance with the image quality enhancement program 124 executed on the memory 66. The image quality enhancement processing is processing of inputting the RAW image 75A (refer to FIG. 2) into the trained model 106 stored in the storage 64, causing the trained model 106 to generate and output a high resolution image 75Al that is an image obtained by enhancing a resolution of the RAW image 75A, and causing the processor 62 to acquire the high resolution image 75A1. The high resolution image 75Al is an example of an “inference result” according to the present disclosure.

The RAW image 75A is an image having the same resolution as the example image 94, and the high resolution image 75Al is an image having the same resolution as the correct answer image 96 (refer to FIGS. 3 and 4). The processor 62 generates the image file 75B by performing the image processing including the development on the high resolution image 75A1 and stores the generated image file 75B in the image memory 46.

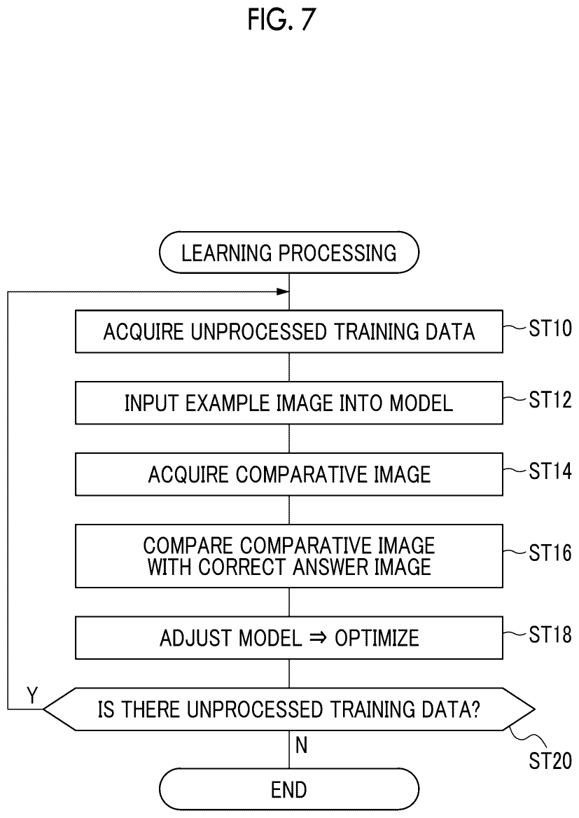

Next, an action of a part of the learning device 79 according to the present disclosure will be described with reference to FIG. 7. FIG. 7 illustrates an example of a flow of the learning processing executed by the processor 80. The flow of learning processing illustrated in FIG. 7 is an example of a “method of generating a trained model” according to the present disclosure.

In the learning processing illustrated in FIG. 7, first, in step ST10, processing of step ST10 in which the processor 80 acquires unprocessed training data 92 (that is, the training data 92 not used in the learning processing illustrated in FIG. 7) from the storage 82 is executed. Then, the learning processing transitions to step ST12.

In step ST12, the processor 80 inputs the example image 94 included in the training data 92 acquired in step ST10 into the model 98. After the processing of step ST12 is executed, the learning processing transitions to step ST14. The comparative image 100 is output from the model 98 by executing the processing of step ST12.

In step ST14, the processor 80 acquires the comparative image 100 output from the model 98. After the processing of step ST14 is executed, the learning processing transitions to step ST16.

In step ST16, the processor 80 compares the comparative image 100 acquired in step ST14 with the correct answer image 96 included in the training data 92 acquired in step ST10. After the processing of step ST16 is executed, the learning processing transitions to step ST18.

In step ST18, the processor 80 adjusts the model 98 using the plurality of adjustment values 104 obtained by comparing the comparative image 100 with the correct answer image 96 in step ST16. The model 98 is optimized by repeatedly executing the processing of step ST18 based on all pieces of the training data 92 stored in the storage 82. After the processing of step ST18 is executed, the learning processing transitions to step ST20.

In step ST20, the processor 80 determines whether or not the unprocessed training data 92 is stored in the storage 82. In step ST20, in a case where the unprocessed training data 92 is stored in the storage 82, a positive determination is made, and the learning processing transitions to step ST10. In step ST20, in a case where the unprocessed training data 92 is not stored in the storage 82, a negative determination is made, and the learning processing is finished.

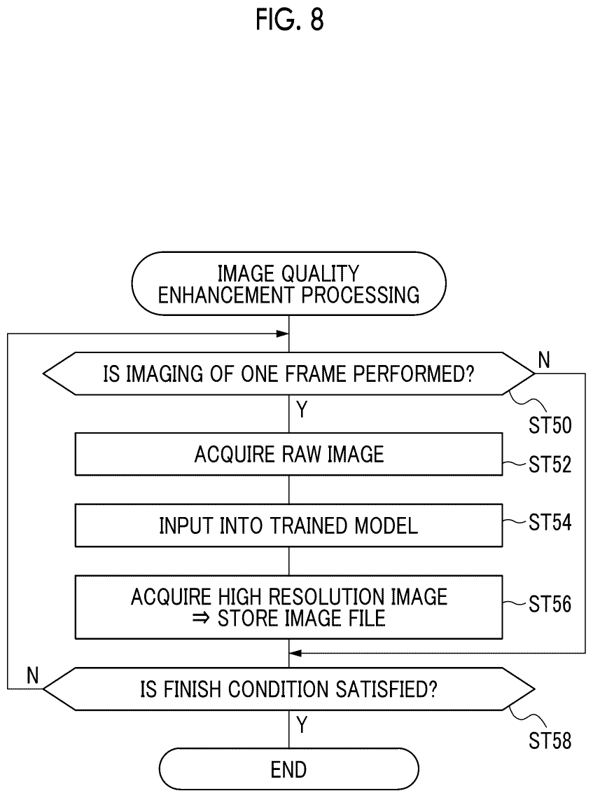

Next, an action of a part of the imaging apparatus 10 according to the present disclosure will be described with reference to FIG. 8. For convenience of description, this description is based on an assumption that the trained model 106 is already stored in the storage 64.

In the image quality enhancement processing illustrated in FIG. 8, first, in step ST50, the processor 62 determines whether or not imaging of one frame is performed by the image sensor 20. In step ST50, in a case where imaging of one frame is not performed by the image sensor 20, a negative determination is made, and the image quality enhancement processing transitions to step ST58. In a case where imaging of one frame is performed by the image sensor 20, a positive determination is made, and the image quality enhancement processing transitions to step ST52.

In step ST52, the processor 62 acquires the RAW image 75A from the image sensor 20. After the processing of step ST52 is executed, the image quality enhancement processing transitions to step ST54.

In step ST54, the processor 62 inputs the RAW image 75A acquired in step ST52 into the trained model 106. After the processing of step ST54 is executed, the image quality enhancement processing transitions to step ST56. By executing the processing of step ST54, the trained model 106 generates and outputs an image obtained by enhancing the image quality of the RAW image 75A, that is, the high resolution image 75A1.

In step ST56, the processor 62 acquires the high resolution image 75A1. The processor 62 generates the image file 75B based on the high resolution image 75Al and stores the image file 75B in the image memory 46. After the processing of step ST56 is executed, the image quality enhancement processing transitions to step ST58.

In step ST58, the processor 62 determines whether or not a condition (hereinafter, referred to as a “finish condition”) under which the image quality enhancement processing is finished is satisfied. Examples of the finish condition include a condition that an instruction to finish the image quality enhancement processing is received by the reception device 76. In step ST58, in a case where the finish condition is not satisfied, a negative determination is made, and the image quality enhancement processing transitions to step ST50. In step ST58, in a case where the finish condition is satisfied, a positive determination is made, and the image quality enhancement processing is finished.

As described above, the training data 92 according to the present embodiment is used for the machine learning of the model 98. The trained model 106 is generated by performing the machine learning on the model 98. The training data 92 comprises the example image 94 and the correct answer image 96, in which the example image 94 and the correct answer image 96 are associated with each other. The correct answer image 96 is an image obtained by combining the first to fourth single images 108A to 108D, the fifth to eighth single images 110A to 110D, the ninth to twelfth single images 112A to 112D, and the thirteenth to sixteenth single images 114A to 114D. The example image 94 is an image obtained by combining an image representing the first to fourth single images 108A to 108D (for example, the first single image 108A), an image representing the fifth to eighth single images 110A to 110D (for example, the fifth single image 110A), an image representing the ninth to twelfth single images 112A to 112D (for example, the ninth single image 112A), and an image representing the thirteenth to sixteenth single images 114A to 114D (for example, the thirteenth single image 114A). That is, the correct answer image 96 is an image having higher image quality than the example image 94. Accordingly, an image having higher image quality than the RAW image 75A can be generated by inputting the RAW image 75A into the trained model 106 configured as described above.

In the present embodiment, the example image 94 and the correct answer image 96 are created from a plurality of single images (a plurality of unit images). Thus, the example image 94 and the correct answer image 96 can be easily created compared to the example image 94 and the correct answer image 96 that are created without using a plurality of single images. This can contribute to reduction of an effort required for creating the training data 92.

In the training data 92 according to the present embodiment, the correct answer image 96 is an image having an enhanced resolution by combining the image representing the first to fourth single images 108A to 108D, the image representing the fifth to eighth single images 110A to 110D, the image representing the ninth to twelfth single images 112A to 112D, and the image representing the thirteenth to sixteenth single images 114A to 114D. The image having an enhanced resolution refers to an image having an enhanced resolution compared to the image representing the first to fourth single images 108A to 108D, the image representing the fifth to eighth single images 110A to 110D, the image representing the ninth to twelfth single images 112A to 112D, and the image representing the thirteenth to sixteenth single images 114A to 114D. In other words, the image having an enhanced resolution is an image having a larger number of pixels than the image representing the first to fourth single images 108A to 108D, the image representing the fifth to eighth single images 110A to 110D, the image representing the ninth to twelfth single images 112A to 112D, and the image representing the thirteenth to sixteenth single images 114A to 114D. In other words, the image having an enhanced resolution is an image having a higher visual resolution than the image representing the first to fourth single images 108A to 108D, the image representing the fifth to eighth single images 110A to 110D, the image representing the ninth to twelfth single images 112A to 112D, and the image representing the thirteenth to sixteenth single images 114A to 114D. Accordingly, an image having a higher resolution than the RAW image 75A can be output by inputting the RAW image 75A into the trained model 106 obtained by performing the machine learning using the training data 92 configured as described above.

In the training data 92 according to the present embodiment, each of the first to fourth single images 108A to 108D, the fifth to eighth single images 110A to 110D, the ninth to twelfth single images 112A to 112D, and the thirteenth to sixteenth single images 114A to 114D used for creating the example image 94 and the correct answer image 96 are images obtained by performing pixel shifting of 1 pixel and pixel shifting of ½ pixels. Thus, an image having a higher resolution than the RAW image 75A can be obtained without increasing the number of pixels of the photoelectric conversion element 72 of the imaging apparatus 10, by inputting the RAW image 75A into the trained model 106 obtained by performing the machine learning using the example image 94 and the correct answer image 96. That is, an image having a higher resolution than the RAW image 75A can be obtained without increasing a development cost and a manufacturing cost of the photoelectric conversion element 72 of the imaging apparatus 10.

In the training data 92 according to the present embodiment, in each of the first to fourth single images 108A to 108D, the fifth to eighth single images 110A to 110D, the ninth to twelfth single images 112A to 112D, and the thirteenth to sixteenth single images 114A to 114D used for creating the example image 94 and the correct answer image 96, the pixels P of different colors (for example, the pixels P of R, G, and B) are regularly disposed (for example, disposed in the Bayer arrangement). Each of the first to fourth single images 108A to 108D, the fifth to eighth single images 110A to 110D, the ninth to twelfth single images 112A to 112D, and the thirteenth to sixteenth single images 114A to 114D are images subjected to pixel shifting that causes the pixels P of different colors to overlap. For example, the image is subjected to pixel shifting that causes R pixels, G pixels, G pixels, and B pixels to overlap. Accordingly, in a case where a RAW image in which different colors (for example, R, G, and B) are regularly disposed is input into the trained model 106, the trained model 106 can be caused to generate and output an image that does not need demosaicing processing. Consequently, an image having high color reproducibility of the captured subject can be provided to the user or the like of the imaging apparatus 10 compared to that on which the demosaicing processing is performed.

In the training data 92 according to the present embodiment, the example image 94 and the correct answer image 96 are RAW images. Accordingly, the trained model 106 can be caused to generate and output an image having higher image quality (in the above example, a higher resolution) than the RAW image 75A by inputting the RAW image 75A into the trained model 106 generated as described above.

In the training data 92 according to the present embodiment, each of the first to fourth single images 108A to 108D, the fifth to eighth single images 110A to 110D, the ninth to twelfth single images 112A to 112D, and the thirteenth to sixteenth single images 114A to 114D are images that are obtained by performing imaging from different imaging positions via the image sensor 20 of the imaging apparatus 500 and that are shifted by ½ pixels. The example image 94 is an image obtained by combining the first single image 108A having the center 108A1 closest to the centroid G1 in a case where the first to fourth single images 108A to 108D are superimposed on each other, the fifth single image 110A having the center 110A1 closest to the centroid G2 in a case where the fifth to eighth single images 110A to 110D are superimposed on each other, the ninth single image 112A having the center 112A1 closest to the centroid G3 in a case where the ninth to twelfth single images 112A to 112D are superimposed on each other, and the thirteenth single image 114A having the center 114A1 closest to the centroid G4 in a case where the thirteenth to sixteenth single images 114A to 114D are superimposed on each other. Accordingly, reproducibility of the subject that is visible through the image generated and output by the trained model 106 by inputting the RAW image 75A into the trained model 106 can be increased compared to that in a case where an image obtained by combining an image having a center farthest from the centroid G1 among the first to fourth single images 108A to 108D, an image having a center farthest from the centroid G2 among the fifth to eighth single images 110A to 110D, an image having a center farthest from the centroid G3 among the ninth to twelfth single images 112A to 112D, and an image having a center farthest from the centroid G4 among the thirteenth to sixteenth single images 114A to 114D is used as the example image 94.

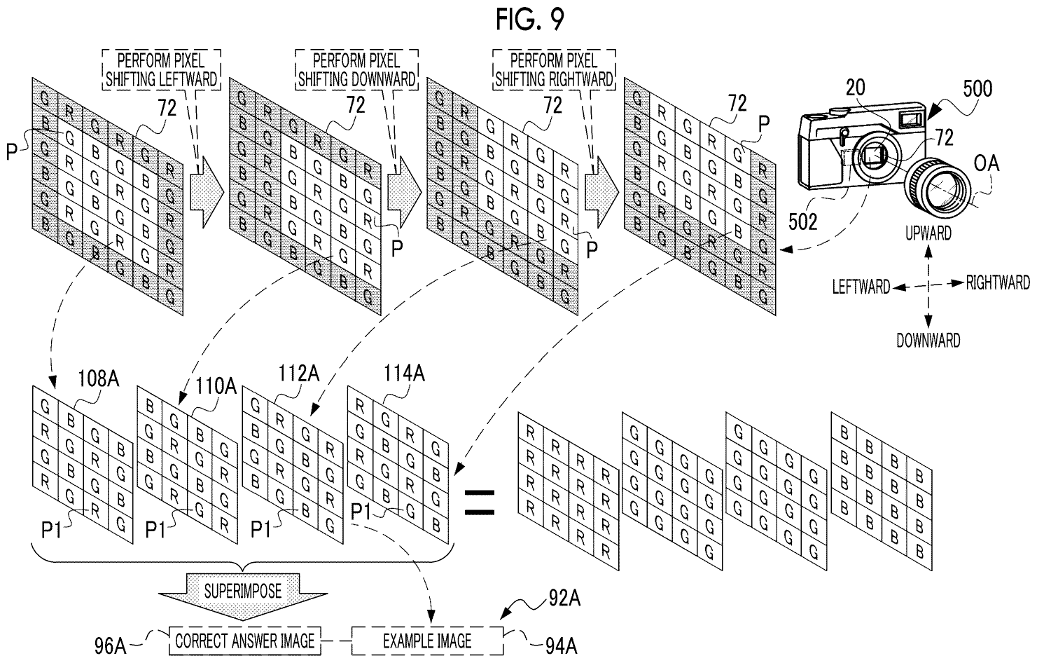

While the training data 92 is illustrated in the embodiment, this is merely an example. For example, as illustrated in FIG. 9, training data 92A may be used instead of the training data 92. The training data 92A is different from the training data 92 in that a correct answer image 96A is applied instead of the correct answer image 96 and that an example image 94A is applied instead of the example image 94. In the example illustrated in FIG. 9, the example image 94A is any one of the first single image 108A, the fifth single image 110A, the ninth single image 112A, or the thirteenth single image 114A. In the example illustrated in FIG. 9, the correct answer image 96A is an image created by combining (for example, superimposing) the first single image 108A, the fifth single image 110A, the ninth single image 112A, and the thirteenth single image 114A. In the example illustrated in FIG. 9, the example image 94A is the first single image 108A, the fifth single image 110A, the ninth single image 112A, or the thirteenth single image 114A. The correct answer image 96A has higher color reproducibility than the example image 94A. Thus, the trained model 106 can be caused to generate and output an image of a RAW format having higher color reproducibility than the RAW image 75A by inputting the RAW image 75A into the trained model 106 generated by optimizing the model 98 through the machine learning using the training data 92A. While the correct answer image 96A is illustrated, the correct answer image 96 may be applied. In this case, the trained model 106 can be caused to generate and output an image having an enhanced resolution as in the example illustrated in FIG. 6. The same applies to the following modification example.

While the first single image 108A, the fifth single image 110A, the ninth single image 112A, and the thirteenth single image 114A are illustrated in the example illustrated in FIG. 9, this is merely an example. For example, instead of the first single image 108A, the fifth single image 110A, the ninth single image 112A, and the thirteenth single image 114A, the second single image 108B, the sixth single image 110B, the tenth single image 112B, and the fourteenth single image 114B may be used, the third single image 108C, the seventh single image 110C, the eleventh single image 112C, and the fifteenth single image 114C may be used, or the fourth single image 108D, the eighth single image 110D, the twelfth single image 112D, and the sixteenth single image 114D may be used. The same applies to the following modification example.

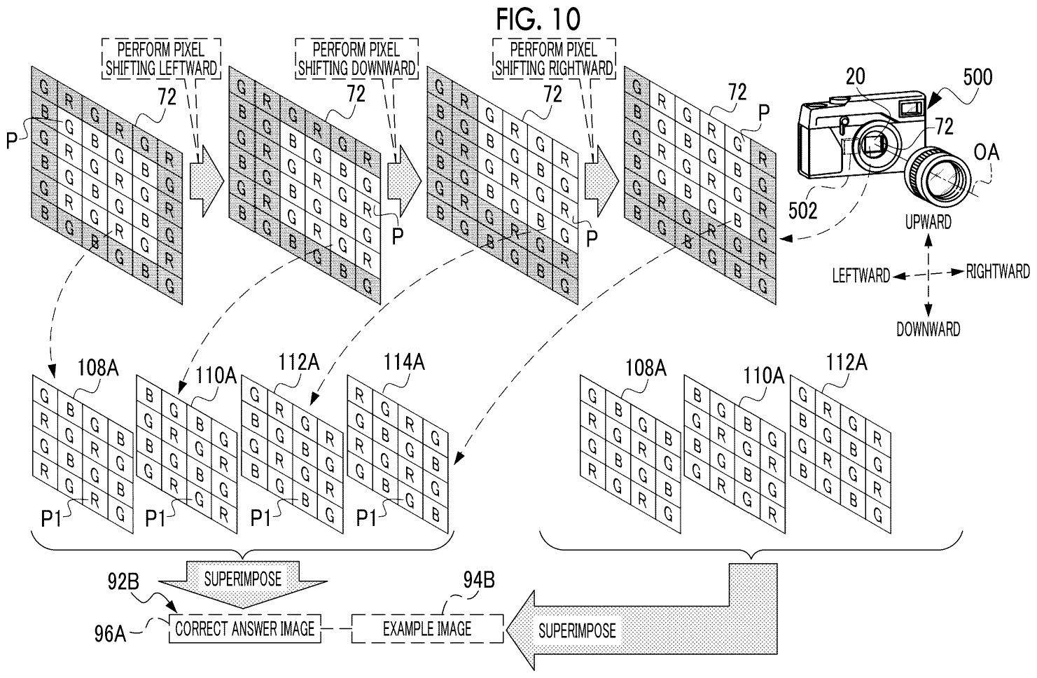

While the training data 92A is illustrated in the example illustrated in FIG. 9, this is merely an example. For example, as illustrated in FIG. 10, training data 92B may be used instead of the training data 92A. The training data 92B is different from the training data 92A in that an example image 94B is applied instead of the example image 94A. The example image 94B is an example of a “first image” according to the present disclosure. The example image 94B is an image based on three or less images among the first single image 108A, the fifth single image 110A, the ninth single image 112A, and the thirteenth single image 114A. In the example illustrated in FIG. 10, an image based on the first single image 108A, the fifth single image 110A, and the ninth single image 112A is illustrated as the example image 94B. Examples of the image based on the first single image 108A, the fifth single image 110A, and the ninth single image 112A include an image created by combining (for example, superimposing in units of the pixels P1 at positions corresponding to each other) the first single image 108A, the fifth single image 110A, and the ninth single image 112A.

As described above, in a case where the RAW image 75A having the same image quality as the example image 94B is input into the trained model 106 generated by optimizing the model 98 by performing the machine learning based on the training data 92B in which the image based on three or less images among the first single image 108A, the fifth single image 110A, the ninth single image 112A, and the thirteenth single image 114A is used as the example image 94B, the trained model 106 can be caused to generate and output an image having higher image quality than the input RAW image 75A.

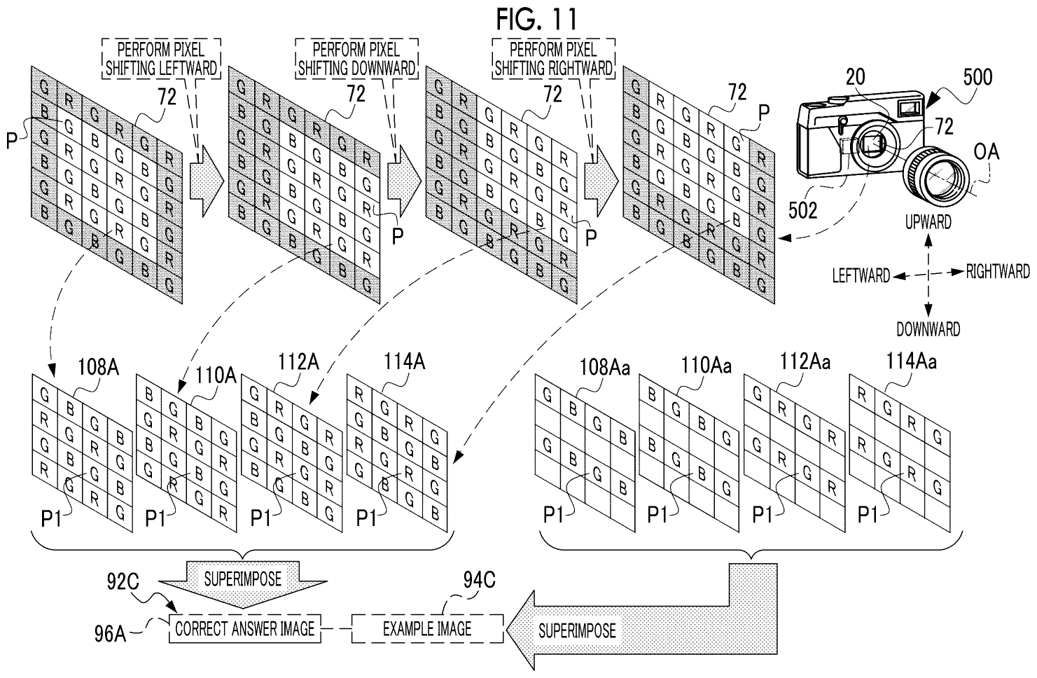

While the training data 92A is illustrated in the example illustrated in FIG. 9, this is merely an example. For example, as illustrated in FIG. 11, training data 92C may be used instead of the training data 92A. The training data 92C is different from the training data 92A in that the correct answer image 96A (refer to FIG. 10) and an example image 94C are applied. The example image 94C is an example of a “second image” according to the present disclosure. The example image 94C is an image obtained using a first thinned-out image 108Aa, a second thinned-out image 110Aa, a third thinned-out image 112Aa, and a fourth thinned-out image 114Aa. In a case where N is an even number, the first thinned-out image 108Aa is an image obtained by thinning out an N-th row of the first single image 108A. The second thinned-out image 110Aa is an image obtained by thinning out an N-th row of the fifth single image 110A. The third thinned-out image 112Aa is an image obtained by thinning out an N-th row of the ninth single image 112A. The fourth thinned-out image 114Aa is an image obtained by thinning out an N-th row of the thirteenth single image 114A.

In the example illustrated in FIG. 11, an image created by combining (for example, superimposing in units of the pixels P1 at positions corresponding to each other) the first thinned-out image 108Aa, the second thinned-out image 110Aa, the third thinned-out image 112Aa, and the fourth thinned-out image 114Aa is illustrated as the example image 94C.

While a thinning-out pattern of the N-th row is illustrated, other thinning-out patterns (for example, a thinning-out pattern of an N-th column or a thinning-out pattern of the N-th row and the N-th column) may be used. While the first thinned-out image 108Aa, the second thinned-out image 110Aa, the third thinned-out image 112Aa, and the fourth thinned-out image 114Aa are illustrated, this is merely an example. The example image 94C may be an image obtained by combining (for example, superimposing in units of the pixels P1 at positions corresponding to each other) three or less images among the first thinned-out image 108Aa, the second thinned-out image 110Aa, the third thinned-out image 112Aa, and the fourth thinned-out image 114Aa.

As described above, in a case where the RAW image 75A (for example, the RAW image 75A in which the pixels Pl are thinned out in the same thinning-out pattern as the example illustrated in FIG. 11) having the same image quality as the example image 94C is input into the trained model 106 generated by optimizing the model 98 by performing the machine learning based on the training data 92C in which the image created by combining the first thinned-out image 108Aa, the second thinned-out image 110Aa, the third thinned-out image 112Aa, and the fourth thinned-out image 114Aa is used as the example image 94C, the trained model 106 can be caused to generate and output an image having higher image quality than the input RAW image 75A.

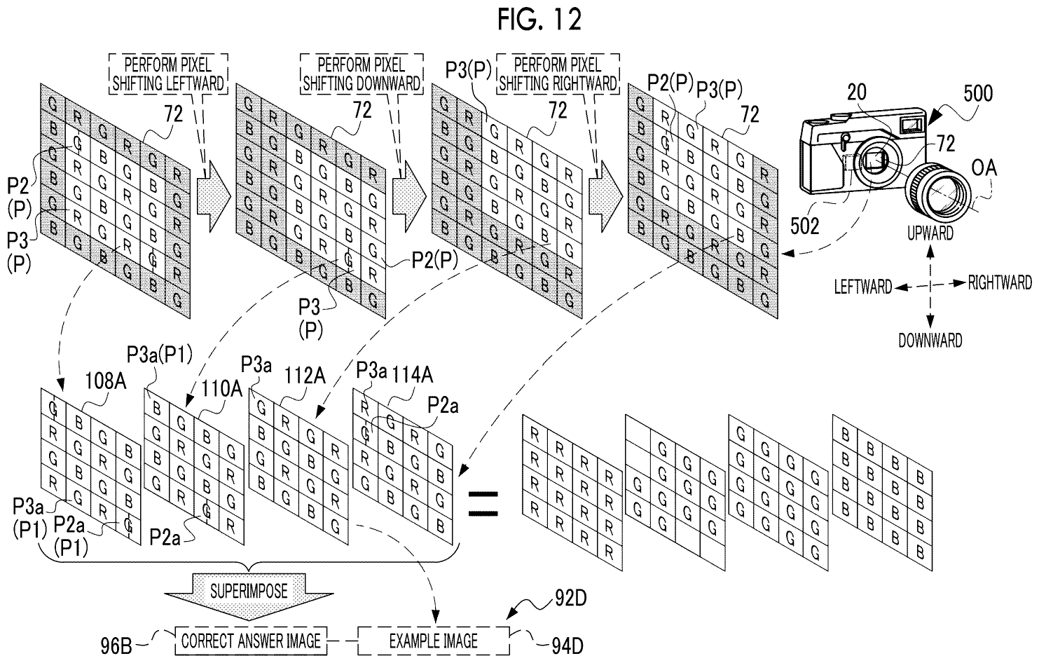

While the training data 92A is illustrated in the example illustrated in FIG. 9, this is merely an example. For example, as illustrated in FIG. 12, training data 92D may be used instead of the training data 92A. The training data 92D is different from the training data 92A in that the correct answer image 96B and an example image 94D are applied.

While a photoelectric conversion element not having a function of detecting a phase difference is illustrated as the photoelectric conversion element 72 in the embodiment, this is merely an example. For example, as illustrated in FIG. 12, the photoelectric conversion element 72 may be a photoelectric conversion element having a function of detecting a phase difference, that is, a photoelectric conversion element including a phase difference pixel P2 and a non-phase difference pixel P3. The phase difference pixel P2 is a pixel for detecting a phase difference. The phase difference pixel P2 is a G pixel. The non-phase difference pixel P3 is the same pixel as the pixel P (that is, a pixel not used for detecting a phase difference). In the photoelectric conversion element 72, the phase difference pixel P2 and the non-phase difference pixel P3 are regularly disposed while the disposition pattern of the R pixels, the G pixels, and the B pixels described in the embodiment is maintained.

The first single image 108A, the fifth single image 110A, the ninth single image 112A, and the thirteenth single image 114A obtained by performing imaging via the image sensor 20 including the photoelectric conversion element 72 configured as described above include pixels P2a and P3a. The pixel P2a is a pixel corresponding to the pixel P2, and the pixel P3a is a pixel corresponding to the non-phase difference pixel P3. The first single image 108A, the fifth single image 110A, the ninth single image 112A, and the thirteenth single image 114A are images subjected to pixel shifting to positions at which the pixel P3a overlaps with the pixel P2a in a case where the first single image 108A, the fifth single image 110A, the ninth single image 112A, and the thirteenth single image 114A are combined (for example, in a case where the first single image 108A, the fifth single image 110A, the ninth single image 112A, and the thirteenth single image 114A are superimposed on each other).

The correct answer image 96B is an image created by combining the first single image 108A, the fifth single image 110A, the ninth single image 112A, and the thirteenth single image 114A (for example, superimposing the first single image 108A, the fifth single image 110A, the ninth single image 112A, and the thirteenth single image 114A on each other). In this case, the pixel P2a and the pixel P3a are superimposed on each other among the first single image 108A, the fifth single image 110A, the ninth single image 112A, and the thirteenth single image 114A. The R pixels, the G pixels, and the B pixels are also superimposed on each other.

The example image 94D is any of the first single image 108A, the fifth single image 110A, the ninth single image 112A, or the thirteenth single image 114A. The example image 94D may be an image obtained by combining (for example, superimposing in units of the pixels P1 at positions corresponding to each other) three or less images among the first single image 108A, the fifth single image 110A, the ninth single image 112A, and the thirteenth single image 114A.

By optimizing the trained model 106 by performing the machine learning based on the training data 92D configured as illustrated in FIG. 12, even in a case where the photoelectric conversion element 72 of the image sensor 20 mounted on the imaging apparatus 10 is a photoelectric conversion element in which the phase difference pixel P2 and the non-phase difference pixel P3 are disposed, the trained model 106 can be caused to generate and output an image having higher image quality than the input RAW image 75A in a case where the RAW image 75A (for example, the RAW image 75A in which the pixel P2a and the pixel P3a are mixed) having the same image quality as the example image 94D is input into the trained model 106.

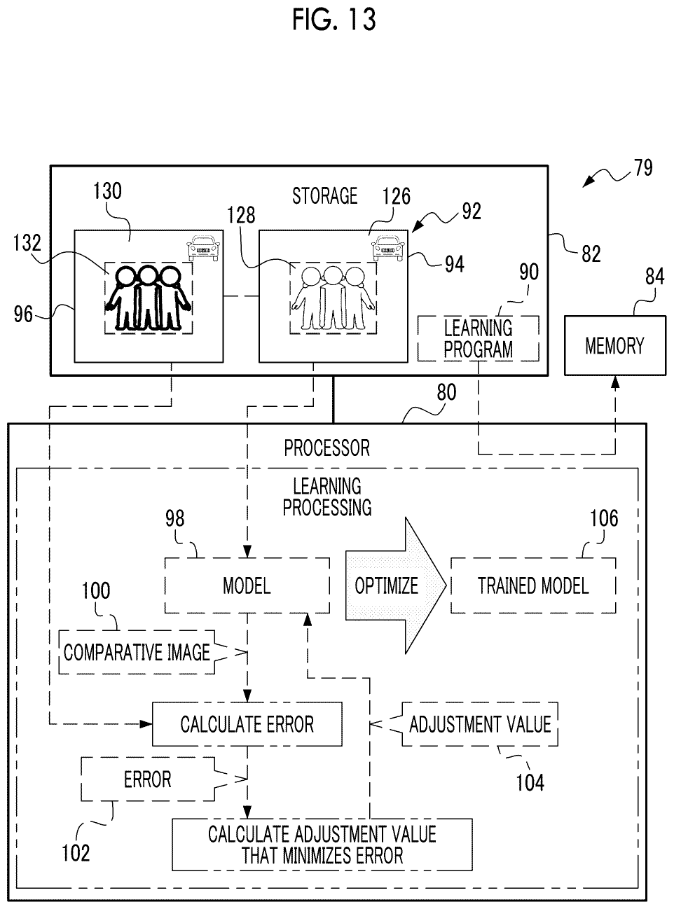

For example, as illustrated in FIG. 13, the example image 94 may include a non-focusing region 126 (that is, a region out of focus) and a focusing region 128 (that is, a region in focus). In a case where the example image 94 is used, the correct answer image 96 also includes a position corresponding to the non-focusing region 126 in the example image 94, and a focusing region 132 is included at a position corresponding to the focusing region 128 in the example image 94. Degrees of image quality enhancement of a non-focusing region 130 and the focusing region 132 are different from each other. In the example illustrated in FIG. 13, the degree of image quality enhancement of the non-focusing region 130 is smaller than the degree of image quality enhancement of the focusing region 132.

By optimizing the trained model 106 by performing the machine learning based on the training data 92 including the example image 94 and the correct answer image 96 configured as described above, the trained model 106 can be caused to generate and output an image in which image quality of the focusing region is better than image quality of the non-focusing region, in a case where the RAW image 75A including the non-focusing region and the focusing region is input into the trained model 106.

While an example of a form in which the degree of image quality enhancement of the non-focusing region 130 is smaller than the degree of image quality enhancement of the focusing region 132 is illustrated, this is merely an example. The degree of image quality enhancement of the focusing region 132 may be smaller than the degree of image quality enhancement of the non-focusing region 130.

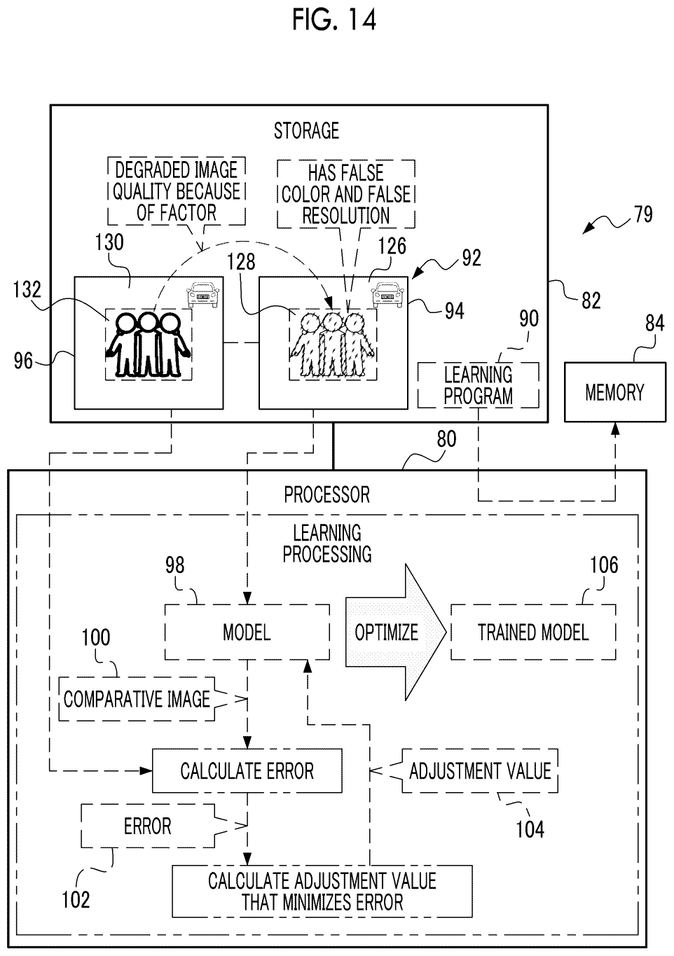

For example, as illustrated in FIG. 14, an image having improved image quality compared to a single image because of a factor affecting the image quality (hereinafter, simply referred to as the “factor”) may be used as the correct answer image 96, and an image having degraded image quality compared to the correct answer image 96 because of the factor may be used as the example image 94. In the example illustrated in FIG. 14, the image quality of the focusing region 128 of the example image 94 is degraded below the image quality of the focusing region 132 of the correct answer image 96 because of the factor. The example image 94 illustrated in FIG. 14 does not benefit from the factor and thus, is an image having degraded image quality by a degree corresponding to the factor compared to the example image 94 that benefits from the factor to have improved image quality.

Examples of the factor include a focal length, an F number, a lens characteristic (for example, an inherent characteristic (an MTF, an aberration, and/or shading) that varies depending on a lens setting), a thinning-out characteristic between the pixels P, a gradation correction function, a gain correction function, and a noise reducing function. That is, the correct answer image 96 is an image created from a plurality of single images (a plurality of unit images) obtained using the focal length, the F number, the lens characteristic, the thinning-out characteristic between the pixels P, the gradation correction function, the gain correction function, and the noise reducing function that implement a certain level of image quality or higher. The correct answer image 96 is created from a plurality of single images (a plurality of unit images) having enhanced image quality using the focal length, the F number, the lens characteristic, the thinning-out characteristic between the pixels P, the gradation correction function, the gain correction function, and the noise reducing function.

The example image 94 illustrated in FIG. 14 is an image created from a plurality of single images that are affected by image quality degradation caused by the focal length, image quality degradation caused by the F number, image quality degradation caused by the lens characteristic, image quality degradation caused by the thinning-out characteristic between the pixels P, image quality degradation caused by not using the gradation correction function or decreasing a level of use of the gradation correction function to less than a certain level, image quality degradation caused by not using the gain correction function or decreasing a level of use of the gain correction function to less than a certain level, and image quality degradation caused by not using the noise reducing function or decreasing a level of use of the noise reducing function to less than a certain level. In other words, the example image 94 illustrated in FIG. 14 is an image having lower image quality than the example image 94 created from a plurality of single images that are affected by image quality enhancement achieved by the focal length, image quality enhancement achieved by the F number, image quality enhancement achieved by the lens characteristic, image quality enhancement achieved by the thinning-out characteristic between the pixels P, image quality enhancement achieved by using the gradation correction function or increasing the level of use of the gradation correction function to a certain level or higher, image quality enhancement achieved by using the gain correction function or increasing the level of use of the gain correction function to a certain level or higher, and image quality enhancement achieved by using the noise reducing function or increasing the level of use of the noise reducing function to a certain level or higher.

The example image 94 is an image having image quality that is assumed as the image quality of the RAW image 75A generated by the imaging apparatus 10 (or an image obtained by performing the image processing on the RAW image 75A via the image processing engine 12). For example, set values of the minimum levels of the focal length, the F number, the lens characteristic, the thinning-out characteristic between the pixels P, the gradation correction function, the gain correction function, and the noise reducing function illustrated as the factor (that is, set values for setting the image quality of the example image 94 its the minimum level) are the same as set values of the focal length, the F number, the lens characteristic, the thinning-out characteristic between the pixels P, the gradation correction function, the gain correction function, and the noise reducing function, respectively, used for the imaging apparatus 10 (set values for setting the image quality of the RAW image 75A to its minimum level). While the focal length, the F number, the lens characteristic, the thinning-out characteristic between the pixels P, the gradation correction function, the gain correction function, and the noise reducing function are illustrated, the image quality adjustment performed on the RAW image 75A by the imaging apparatus 10, that is, the color space conversion processing, the brightness filter processing, the color difference processing, and/or the resize processing or the like, may also be performed on the example image 94 in a case where the image quality adjustment for the RAW image 75A is performed by the imaging apparatus 10 using the color space conversion processing, the brightness filter processing, the color difference processing, and/or the resize processing or the like. The image quality adjustment performed on the RAW image 75A by the imaging apparatus 10, that is, the color space conversion processing, the brightness filter processing, the color difference processing, and/or the resize processing or the like, is included in a concept of the factor.

In the example illustrated in FIG. 14, the example image 94 is a single image having a false color and a false resolution that are assumed in advance as a false color and a false resolution of the RAW image 75A generated by the imaging apparatus 10 (for example, an image having the largest generated amounts of the false color and the false resolution specified by quantifying the generated amounts of the false color and the false resolution in advance through visual inspection and/or computer simulation), or an image generated based on the single image having the false color and the false resolution that are assumed in advance as the false color and the false resolution of the RAW image 75A generated by the imaging apparatus 10. For example, the image generated based on the single image having the false color and the false resolution refers to an image obtained by processing the single image having the false color and the false resolution. Examples of the image obtained by processing the single image having the false color and the false resolution include an image obtained by thinning out the single image having the false color and the false resolution or an image file obtained by developing the single image having the false color and the false resolution. In the example illustrated in FIG. 14, the focusing region 128 includes an image region of the false color and an image region of the false resolution. However, this is merely an example. The image region of the false color and/or the image region of the false resolution may be included in an image region other than the focusing region 128. The false color and the false resolution are included in the concept of the factor.

By optimizing the trained model 106 by performing the machine learning based on the training data 92 including the example image 94 and the correct answer image 96 configured as illustrated in FIG. 14, the trained model 106 can be caused to generate and output an image having higher image quality than the input RAW image 75A in a case where the RAW image 75A having degraded image quality because of the factor is input into the trained model 106. Compared to the trained model 106 in a case where a single image having the smallest amounts of the false color and the false resolution is used as the example image 94, the trained model 106 can be caused to generate and output an image in which the false color and the false resolution of the regions corresponding to the focusing region of the RAW image 75A are suppressed compared to those in the input RAW image 75A, in a case where the RAW image 75A including the focusing region including the image region of the false color and the image region of the false resolution is input into the trained model 106.

While the focal length, the F number, the lens characteristic, the thinning-out characteristic between the pixels P, the gradation correction function, the gain correction function, the noise reducing function, and the like are illustrated in the example illustrated in FIG. 14 as an example of the factor, this is merely an example. The factor may be one or more of the focal length, the F number, the lens characteristic, the thinning-out characteristic between the pixels P, the gradation correction function, the gain correction function, and the noise reducing function. The factor may be one or more of the focal length, the F number, the lens characteristic, the thinning-out characteristic between the pixels P, the gradation correction function, the gain correction function, the noise reducing function, the color space conversion processing, the brightness filter processing, the color difference processing, the resize processing, the false color, and/or the false resolution. While a single image having the false color and the false resolution is illustrated in the example illustrated in FIG. 14, this is merely an example. A single image having the false color or the false resolution may be used. While an example of a form in which the image quality of the focusing region 128 is degraded by the factor is illustrated in the example illustrated in FIG. 14, this is merely an example. Image quality of an image region other than the focusing region 128 may be degraded by the factor.

A plurality of trained models 106 generated by optimizing the model 98 by performing the machine learning on the model 98 based on the training data 92 including the example image 94 and the correct answer image 96 on which one type of the factor and/or a plurality of types of the factor different from each other are reflected may be mounted on the imaging apparatus 10. In this case, the RAW image 75A having enhanced image quality may be generated and output by the trained model 106 by inputting the RAW image 75A into one or more trained models 106 selected from the plurality of trained models 106 in accordance with an instruction provided from the user or the like and/or various conditions.

As described above, by mounting, on the imaging apparatus 10, one or more trained models 106 generated by optimizing the model 98 by performing the machine learning on the model 98 based on the training data 92 including the example image 94 and the correct answer image 96 on which one type of the factor and/or the plurality of types of the factor different from each other are reflected, an image having enhanced image quality compared to the RAW image 75A input into the trained model 106 can be obtained by inputting the RAW image 75A into the trained model 106 even in a case where a function of performing the image quality adjustment is not comprised in the imaging apparatus 10.

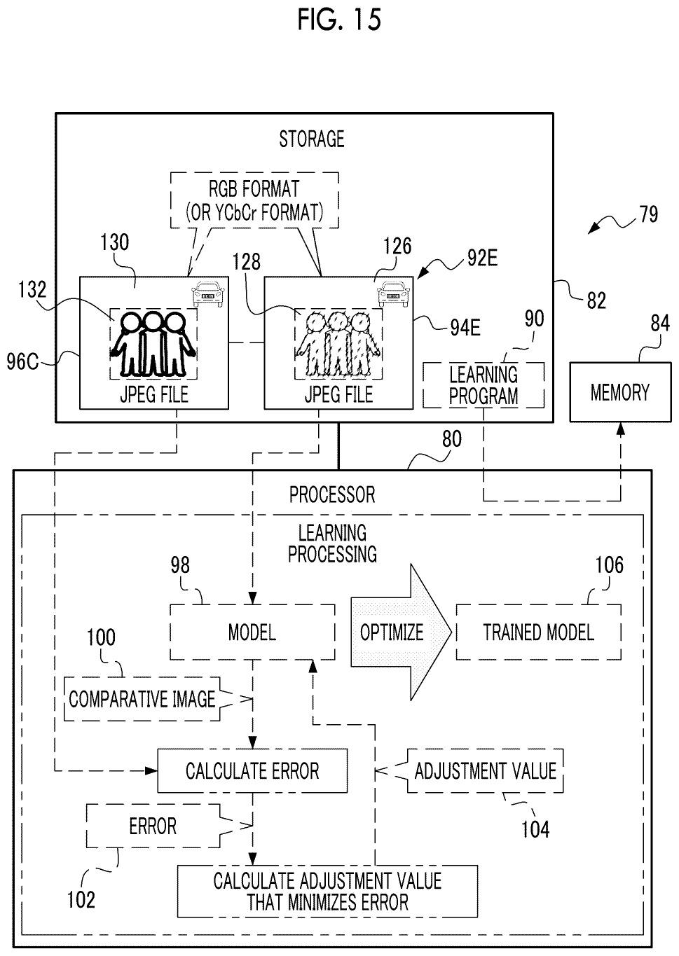

While an example of a form in which the trained model 106 mounted on the imaging apparatus 10 is caused to generate and output an image of the RAW format is illustrated in the embodiment, this is merely an example. For example, the trained model 106 mounted on the imaging apparatus 10 may be caused to generate and output an image based on the RAW image 75A (for example, an image file of a predetermined file format). In order to implement this, training data 92E is used instead of the training data 92 in the example illustrated in FIG. 15. The training data 92E includes an example image 94E and a correct answer image 96C. The example image 94E is different from the example image 94 illustrated in FIG. 14 in that the example image 94E is a JPEG file including an image of an RGB format. The correct answer image 96C is different from the correct answer image 96 illustrated in FIG. 14 in that the correct answer image 96C is a JPEG file including an image of the RGB format. While an image of the RGB format is illustrated, this is merely an example. An image of a YCbCr format may be used.

By optimizing the trained model 106 by performing the machine learning based on the training data 92E configured as illustrated in FIG. 15, the trained model 106 can be caused to generate and output an image of the RGB format having higher image quality than an input image of the RGB format in a case where the image of the RGB format is input. In a case where a JPEG file is input into the trained model 106, the trained model 106 can be caused to generate and output a JPEG file having higher image quality than the input JPEG file.

While a JPEG file is illustrated in the example illustrated in FIG. 15, this is merely an example. A format of the image file may be TIFF, JPEG XR, MPEG, AVI, or the like.

While an example of a form in which the first single image 108A is used for creating the example image 94 because the center 108A1 is the center closest to the centroid G1 among the centers 108A1 to 108D1 is illustrated in the embodiment (refer to FIG. 5), this is merely an example. Three or less images among the first to fourth single images 108A to 108D may be used for creating the example image 94.

While an example of a form in which the fifth single image 110A is used for creating the example image 94 because the center 110A1 is the center closest to the centroid G2 among the centers 110A1 to 110D1 is illustrated in the embodiment (refer to FIG. 5), this is merely an example. Three or less images among the fifth to eighth single images 110A to 110D may be used for creating the example image 94.

While an example of a form in which the ninth single image 112A is used for creating the example image 94 because the center 112A1 is the center closest to the centroid G3 among the centers 112A1 to 112D1 is illustrated in the embodiment (refer to FIG. 5), this is merely an example. Three or less images among the ninth to twelfth single images 112A to 112D may be used for creating the example image 94.

While an example of a form in which the thirteenth single image 114A is used for creating the example image 94 because the center 114A1 is the center closest to the centroid G4 among the centers 114A1 to 114D1 is illustrated in the embodiment (refer to FIG. 5), this is merely an example. Three or less images among the thirteenth to sixteenth single images 114A to 114D may be used for creating the example image 94.

While a single image in which the R pixels, the G pixels, and the B pixels are regularly disposed is illustrated in the embodiment, the single image may be a monochromic image (for example, an R image consisting of only a plurality of R images, a G image consisting of only a plurality of G images, or a B image consisting of only a plurality of B images).

While an example of a form in which the processor 62 of the image processing engine 12 included in the imaging apparatus 10 performs the image quality enhancement processing has been illustratively described in the embodiment, the present disclosure is not limited to this. For example, a device that performs the image quality enhancement processing may be a device such as a server provided outside the imaging apparatus 10. For example, the server may be implemented by cloud computing. The server may be implemented by network computing such as fog computing, edge computing, or grid computing. While a server is illustrated, this is merely an example. At least one personal computer or the like may be used instead of the server.

While an example of a form in which the image quality enhancement program 124 is stored in the storage 64 has been illustratively described in the embodiment, the present disclosure is not limited to this. For example, the image quality enhancement program 124 may be stored in a portable computer-readable non-transitory storage medium such as an SSD or a USB memory. The image quality enhancement program 124 stored in the non-transitory storage medium is installed on the image processing engine 12 of the imaging apparatus 10. The processor 62 executes the image quality enhancement processing in accordance with the image quality enhancement program 124.

The image quality enhancement program 124 may be stored in a storage device of another computer, a server apparatus, or the like connected to the imaging apparatus 10 through a network, and the image quality enhancement program 124 may be downloaded in response to a request of the imaging apparatus 10 and installed on the image processing engine 12.

The storage device of another computer, a server apparatus, or the like connected to the imaging apparatus 10 or the storage 64 does not necessarily store the entire image quality enhancement program 124 and may store a part of the image quality enhancement program 124. While the image quality enhancement program 124 is mentioned, the same applies to the learning program 90.

While the image processing engine 12, is incorporated in the imaging apparatus 10 illustrated in FIGS. 1 and 2, the present disclosure is not limited to this. For example, the image processing engine 12 may be provided outside the imaging apparatus 10.

While the image processing engine 12 is illustrated in the embodiment, the present disclosure is not limited to this. A device including an ASIC, an FPGA, and/or a PLD may be applied instead of the image processing engine 12. A combination of a hardware configuration and a software configuration may also be used instead of the image processing engine 12.

Various processors illustrated below can be used as a hardware resource for executing the image quality enhancement processing and/or the learning processing described in the embodiment. Examples of the processor include a CPU that is a general-purpose processor functioning as the hardware resource for executing the image quality enhancement processing and/or the learning processing by executing software, that is, a program. Examples of the processor also include a dedicated electric circuit such as an FPGA, a PLD, or an ASIC that is a processor having a circuit configuration dedicatedly designed to execute specific processing. A memory is incorporated in or connected to any of the processors, and any of the processors executes the image quality enhancement processing and/or the learning processing using the memory.

The hardware resource for executing the image quality enhancement processing and/or the learning processing may be composed of one of the various processors or be composed of a combination of two or more processors of the same type or different types (for example, a combination of a plurality of FPGAs or a combination of a CPU and an FPGA). The hardware resource for executing the image quality enhancement processing and/or the learning processing may also be one processor.

Examples of the hardware resource composed of one processor include, first, a form of one processor composed of a combination of one or more CPUs and software, in which the processor functions as the hardware resource for executing the image quality enhancement processing and/or the learning processing. Second, as represented by an SoC or the like, a form of using a processor that implements functions of the entire system including a plurality of hardware resources for executing the image quality enhancement processing and/or the learning processing in one IC chip is included. As described above, the image quality enhancement processing and/or the learning processing are implemented using one or more of the various processors as the hardware resource.

More specifically, an electric circuit in which circuit elements such as semiconductor elements are combined can be used as a hardware structure of the various processors. The image quality enhancement processing and/or the learning processing is merely an example. Accordingly, it is possible to delete an unnecessary step, add a new step, or change a processing order without departing from the gist of the present disclosure.

Above described content and illustrated content are detailed description for parts according to the present disclosure and are merely an example of the present disclosure. For example, description related to the above configurations, functions, actions, and effects is description related to examples of configurations, functions, actions, and effects of the parts according to the present disclosure. Thus, it is possible to remove an unnecessary part, add a new element, or replace a part in the above described content and the illustrated content without departing from the gist of the present disclosure. Particularly, description related to common technical knowledge or the like that is not required to be described for embodying the present disclosure is omitted in the above described content and the illustrated content in order to avoid complication and facilitate understanding of the parts according to the present disclosure.

All documents, patent applications, and technical standards disclosed in the present specification are incorporated in the present specification by reference to the same extent as those in a case where each of the documents, patent applications, and technical standards are specifically and individually indicated to be incorporated by reference.

The following appendixes are further disclosed with respect to the above embodiment.

### Appendix 1

Training data used for machine learning of a model, the training data comprising a correct answer image obtained by combining a plurality of single images, and an example image representing the plurality of single images.

### Appendix 2

A trained model that is generated by optimizing the model by performing the machine learning on the model using the training data according to Appendix 1.

### Appendix 3

A program (for example, the image quality enhancement program 124) causing a computer (for example, the image processing engine 12) to execute image quality enhancement processing comprising inputting a captured image obtained by performing imaging via an image sensor into the trained model according to Appendix 2, and acquiring an inference result output from the trained model in accordance with input of the captured image.

### Appendix 4

A program (for example, the learning program 90) causing a computer (for example, the learning device 79) to execute learning processing of generating a trained model by performing machine learning on a model using training data including a correct answer image and an example image, the correct answer image being an image obtained by combining a plurality of single images, the example image being an image representing the plurality of single images, the learning processing comprising inputting the example image into the model, outputting an evaluation target image in accordance with input of the example image via the model, and optimizing the model based on a comparison result between the evaluation target image and the correct answer image.

### Appendix 5

A computer-readable non-transitory storage medium storing a program (for example, the image quality enhancement program 124) causing a computer (for example, the image processing engine 12) to execute image quality enhancement processing comprising inputting a captured image obtained by performing imaging via an image sensor into the trained model according to Appendix 2, and acquiring an inference result output from the trained model in accordance with input of the captured image.

### Appendix 6

A computer-readable non-transitory storage medium storing a program (for example, the learning program 90) causing a computer (for example, the learning device 79) to execute learning processing of generating a trained model by performing machine learning on a model using training data including a correct answer image and an example image, the correct answer image being an image obtained by combining a plurality of single images, the example image being an image representing the plurality of single images, the learning processing comprising inputting the example image into the model, outputting an evaluation target image in accordance with input of the example image via the model, and optimizing the model based on a comparison result between the evaluation target image and the correct answer image.

What is claimed is:

1. Training data used for machine learning of a model, the training data comprising:
a correct answer image obtained by combining a plurality of single images; and
an example image representing the plurality of single images.

2. The training data according to claim 1,
wherein the correct answer image is an image having an enhanced resolution by combining the plurality of single images.

3. The training data according to claim 1,
wherein the correct answer image is an image having an enhanced resolution compared to the example image.

4. The training data according to claim 1,
wherein the correct answer image is an image having a larger number of pixels than the example image.

5. The training data according to claim 1,
wherein the correct answer image is an image having a higher visual resolution than the example image.

6. The training data according to claim 2,
wherein each of the plurality of single images is an image subjected to pixel shifting.

7. The training data according to claim 6,
wherein each of the plurality of single images is an image shifted by ½ pixels.

8. The training data according to claim 1,
wherein each of the plurality of single images is an image subjected to pixel shifting, and
the correct answer image is an image having enhanced image quality by combining the plurality of single images.

9. The training data according to claim 8,
wherein pixels of different colors are regularly disposed in the plurality of single images, and
each of the plurality of single images is an image subjected to pixel shifting to a position at which the pixels of the different colors overlap.

10. The training data according to claim 5,
wherein the plurality of single images are obtained by performing imaging via a first image sensor including a phase difference pixel and a non-phase difference pixel, and
each of the plurality of single images is an image subjected to pixel shifting to a position at which a pixel corresponding to the non-phase difference pixel overlaps with a pixel corresponding to the phase difference pixel.

11. The training data according to claim 1,
wherein the correct answer image is an image having improved image quality compared to the single images because of a factor that affects the image quality, and
the example image is an image having degraded image quality compared to the correct answer image because of the factor.

12. The training data according to claim 11,
wherein the factor is a focal length, an F number, a lens characteristic, a thinning-out characteristic between pixels, a gradation correction function, a gain correction function, and/or a noise reducing function.

13. The training data according to claim 1,
wherein the correct answer image and the example image include a focusing region and a non-focusing region, and
the correct answer image is an image in which degrees of image quality enhancement of the focusing region and the non-focusing region are different from each other.

14. The training data according to claim 13,
wherein the correct answer image is an image in which the degree of image quality enhancement of the non-focusing region is smaller than the degree of image quality enhancement of the focusing region.

15. The training data according to claim 1,
wherein the correct answer image and the example image are RAW images.

16. The training data according to claim 1,
wherein the correct answer image and the example image are images based on a RAW image.

17. The training data according to claim 1,
wherein the correct answer image and the example image are images of an RGB format or images of a YCbCr format.

18. The training data according to claim 1,
wherein the example image is a first image based on the single images of a number smaller than the number of the plurality of single images among the plurality of single images.

19. The training data according to claim 1,
wherein the example image is a second image obtained by thinning out a pixel in the single images of a number less than or equal to the number of the plurality of single images among the plurality of single images.

20. The training data according to claim 1,
wherein each of the plurality of single images is an image that is obtained by performing imaging from different imaging positions via a second image sensor and that is shifted by ½ pixels, and
the example image is a single image having a center closest to a centroid in a case where the plurality of single images are superimposed on each other among the plurality of single images.

21. The training data according to claim 1,
wherein the example image is a single image having a false color and/or a false resolution among the plurality of single images or an image generated based on the single image having the false color and/or the false resolution among the plurality of single images.

22. A trained model that is generated by optimizing the model by performing the machine learning on the model using the training data according to claim 1.

23. An imaging apparatus comprising:
a first processor; and
a third image sensor,
wherein the first processor is configured to:
input a captured image obtained by performing imaging via the third image sensor into the trained model according to claim 22; and
acquire an inference result output from the trained model in accordance with input of the captured image.

24. A learning device comprising:
a second processor,
wherein the second processor is configured to optimize the model by performing the machine learning on the model using the training data according to claim 1.

25. A method of creating training data used for machine learning of a model, the training data including a correct answer image and an example image, the method comprising:
creating the correct answer image by combining a plurality of single images; and
creating an image representing the plurality of single images as the example image.

26. A method of generating a trained model that is generated by performing machine learning on a model using training data including a correct answer image and an example image,
the correct answer image being an image obtained by combining a plurality of single images,
the example image being an image representing the plurality of single images,
the method comprising:
inputting the example image into the model;
outputting an evaluation target image in accordance with input of the example image via the model; and
optimizing the model based on a comparison result between the evaluation target image and the correct answer image.
